(19) United States
(12) Patent Application Publication
(10) Pub. No.: US 2005/0283623 A1
(43) Pub. Date: Dec. 22, 2005

(54) Computer-based method and apparatus for certifying a file

(76) Inventors: Peter J. Vanderheyden, Naperville, IL (US); Timothy G. Northrup, Summerfield, FL (US); Thomas J. Colson, Clarence Center, NY (US)

Correspondence Address: C. Paul Maliszewski, P.E.;Simpson & Simpson, PLLC, 5555 Main Street, Williamsville, NY, 14221-5406, US

(21) Appl. No.: 10/870,666

(22) Filed: Jun. 17, 2004

(51) Int. Cl. H04L 9/32; G06F 12/14; G06F 11/30

(52) U.S. Cl. 713/193

(57) ABSTRACT

The invention broadly comprises a computer-based method for certifying files using a specially programmed computer. The method sets parameters for identifying files to process and parameters for a processing schedule. An identified file is digitally fingerprinted. In some aspects, a copy of the file is archived. In some aspects, the archived file is renamed and/or converted to a read-only file. The method creates a Bulk Certification Record (BCR), adds the fingerprint to the BCR, and generates processing reports. The method transmits the BCR to a base computer, which compiles BCR information into a Daily Certification Record (DCR). A digital fingerprint is made of the DCR, and the DCR and the DCR fingerprint are given a respective sequential number. The method publishes the DCR, DCR fingerprint, and the respective sequential numbers both electronically and in print media. The present invention also includes an apparatus to certify a file.

### REFERENCE TO COMPUTER PROGRAM LISTING/TABLE APPENDIX

The present application includes a computer program listing appendix on compact disc. Two duplicate compact discs are provided herewith. Each compact disc contains a plurality of files of the computer program listing as follows:

Converted to ASCII Files:

| Name | Size | Created |
|---|---|---|
| BulkCertClientMain_txt.txt | 73.71 KB | Jun. 17, 2004 4:29:33 PM |
| ComputerIdentity_txt.txt | 8.41 KB | Jun. 17, 2004 4:29:33 PM |
| Crypto_txt.txt | 19.67 KB | Jun. 17, 2004 4:29:33 PM |
| IPAccount_txt.txt | 2.14 KB | Jun. 17, 2004 4:29:33 PM |
| IPCertify_txt.txt | 28.42 KB | Jun. 17, 2004 4:29:34 PM |

The computer program listing appendix is hereby expressly incorporated by reference in the present application.

### FIELD OF THE INVENTION

The invention relates generally to the certification of files, and more particularly, to a method and apparatus for using digital fingerprinting to certify the content and date associated with a file.

### BACKGROUND OF THE INVENTION

File integrity is critical in today's business environment. Every business has critical business records, for example, compliance records for the Health Insurance Portability and Accountability Act of 1996 (HIPAA), as well as internal control files for managing customers, manufacturing processes, and other sensitive areas. These records are only as good as the company's ability to prove their integrity. That is, the ability to prove specific content at a specific point in time.

Electronic records have many advantages over paper records. Unfortunately, electronic records can be easily modified, rendering these records less reliable in terms of integrity. This lack of reliability complicates efforts to demonstrate control of files and processes in the event of business or legal proceedings.

Thus, there is a long-felt need to provide a means to ensure integrity of electronic files.

### SUMMARY OF THE INVENTION

The invention broadly comprises a computer-based method for certifying files using a specially programmed computer. The method sets parameters for identifying files to process and parameters for a processing schedule. An identified file is digitally fingerprinted and, in some aspects, the fingerprint is compared to fingerprints of previously processed files. If the fingerprints for the file do not match any of the fingerprints of previously processed files, the file has not been processed. Then, in some aspects, a copy of the file is archived. In some aspects, the archived file is renamed and/or converted to a read-only file. Processing also includes creating a Bulk Certification Record (BCR), adding the fingerprint to the BCR, and generating log and detail files listing details of the method operation. At the end of a session, the method transmits the BCR to a base computer, which compiles BCR information into a Daily Certification Record (DCR). A digital fingerprint is made of the DCR, and the DCR and the DCR fingerprint are given a respective sequential number. The method also publishes the DCR, DCR fingerprint, and the respective sequential numbers both electronically and in print media. The present invention also includes an apparatus to certify a file.

It is a general object of the present invention to provide a method and apparatus for maintaining the integrity of electronic files.

It is another object of the present invention to provide a method and apparatus for certifying the content of an electronic file and the time and date associated with the content.

It is still another object of the present invention to provide a method and apparatus for storing and managing certified electronic files.

It is a further object of the present invention to provide a method and apparatus for publicly publishing certification records regarding certified electronic files.

These and other objects and advantages of the present invention will be readily appreciable from the following description of preferred embodiments of the invention and from the accompanying drawings and claims.

### BRIEF DESCRIPTION OF THE DRAWINGS

FIG. 1 is a block diagram illustrating a present invention computer-based apparatus for certifying a file;

FIGS. 2a and 2b are a process flow chart illustrating a present invention computer-based method and apparatus for certifying a file;

FIGS. 3a through 3f are a programming flow chart for a present invention method and apparatus;

FIGS. 3g and 3h are a programming flow chart further illustrating the collection of digital fingerprints shown in FIGS. 3a through 3f;

FIGS. 3i and 3j are a programming flow chart further illustrating the transmission of collected of digital fingerprints shown in FIGS. 3a through 3f;

FIG. 4 is a screen capture illustrating a configuration tool of the agent;

FIG. 5 is a screen capture further illustrating the configuration of the agent;

FIG. 6 is a screen capture further illustrating the configuration of the agent;

FIG. 7 is a screen capture illustrating a log file listing of the agent;

FIG. 8 is a screen capture illustrating a log file of the agent;

FIG. 9 is a screen capture illustrating the main folders page of the agent;

FIG. 10 is a screen capture illustrating a Detailed Record listing of the agent;

FIG. 11 is a screen capture illustrating a detailed record of the agent;

FIG. 12 is a screen capture illustrating the notification aspects of the agent;

FIG. 13 is a screen capture illustrating an email notification of a successful session of the agent;

FIG. 14 is a screen capture illustrating server settings of the agent;

FIG. 15 is a screen capture illustrating scheduling of the agent;

FIG. 16 is a screen capture further illustrating scheduling of the agent;

FIG. 17 is a screen capture further illustrating scheduling of the agent; and,

FIG. 18 is a screen capture illustrating start-up of the agent.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

In the drawings and written description of the invention, we utilize screen captures taken while operating the software to illustrate the best mode of the invention known to the inventors at the time of application for patent and to enable those having ordinary skill in the art to use the invention. We also include an appendix containing the source code for the computer program of the invention to enable one having ordinary skill in the art to make the invention. The software of the present invention is operatively arranged to operate with a conventional web browser, such as those commercially available from Netscape or Microsoft Corporation. It should be understood that the present invention is not limited to any particular web browser. The present invention is compatible with a variety of operating systems, for example Windows 2000 and Windows XP. It should be understood that the present invention is not limited to any particular operating system.

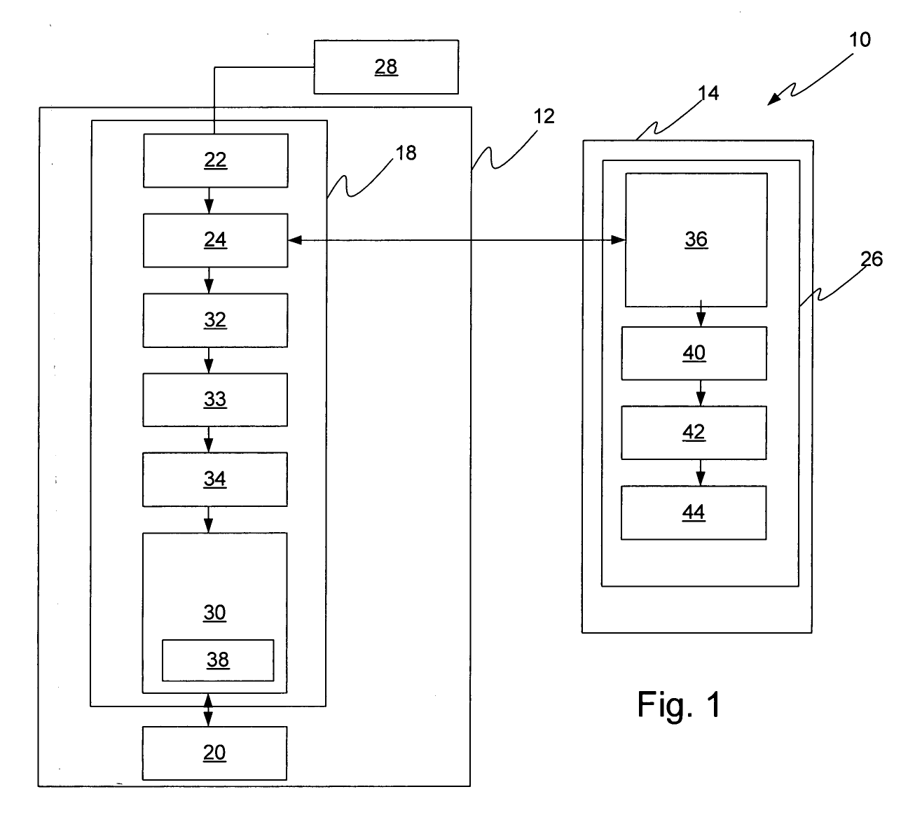

FIG. 1 is a block diagram illustrating a present invention computer-based apparatus 10 for certifying a file. Apparatus 10 includes at least one specially programmed computer 12 and a base computer 14. In FIG. 1, a single computer 12 is shown, however, it should be understood that more than one computer 12 can be used in apparatus 10 and that the use of more than one computer 12 in apparatus 10 is included in the spirit and scope of the claims. In general, computer 12 is located at the location of a user and computer 14 is located in a remote location. Typically, computers 12 and 14 are general-purpose computers, however it should be understood that computers 12 and 14 can be any computer or computing system known in the art, and that such modifications are within the spirit and scope of the claims. Computer 12 includes processing element 18 and archive 20. One function of element 18 is to create a digital fingerprint of a file. Element 18 creates a copy of the file and stores the copy in archive 20. In some aspects, a user can select an alternative location (not shown) for storing a copy of the first file. It should be understood that the description for operations regarding archive 20 also are applicable to such an alternate location. However, in the interest of brevity, applicable operations are referenced only with respect to said archive 20, unless stated otherwise. In FIG. 1, archive 20 is shown in the same computer as element 18, however, it should be understood that element 18 and archive 20 can be in separate computers.

Processing element 18 includes configuring element 22 and transceiver 24. Computer 14 includes packaging element 26. The general operation of each of the elements noted above is now briefly described. Detailed descriptions regarding these operations are provided below. Element 22 is used to set the run schedule for the apparatus and to set various file parameters associated with operation of apparatus 10. Transceiver element 24 sends information regarding the first file, typically after the file is processed by element 18, to packaging element 26. Packaging element 26 receives the information regarding the processed file and performs operations to complete the certification of the file.

Regarding the run schedule, in general, the certification process for apparatus 10 is defined by a certification period, for example, a 24-hour period. It should be understood that the apparatus 10 is not limited to any particular time duration for a certification period. The files and associated fingerprints processed by apparatus 10 during a certification period are certified as a group at the end of the period. The general cycle of operations performed by computer 12 can be referred to as the fingerprinting operations. Each execution of these operations is called a session or run. Apparatus 10 can execute multiple sessions within a certification period. For example, within a 24-hour certification period, hourly sessions can be performed. The intervals for the sessions can be default settings in element 22 or can be modified by a user via user interface 28. Also, a user can manually initiate a session at any time using interface 28. It should be understood that the operations for apparatus 10 are applicable to more than one file during a respective session or certification period.

File parameters in element 22 also can be default settings or can be inputted or modified by a user via interface 28. In some aspects, file parameters include file locations, file identifiers, archive bit control, and selection of a location in which to store digital fingerprints. In some aspects, copying a selected file to archive 20 is optional and an archive select is included among the file parameters. In some aspects, renaming a file copy in archive 20, further described below, and/or converting a file copy in archive 20 to a read-only file, also described further below, are optional. In these cases, file parameters include a rename select and a read-only select, respectively. File locations refer to locations in which to look for files to certify. For example, searches can be directed to specific folders or file locations. File identifiers refer to identification of files to certify. Files may be selected based on a number of criteria, including time of last modification or the file name matching a specific pattern. When multiple folders are specified for scanning, each folder may have its own selection criteria. Some programs include an archive bit that lets other programs know if the file has been backed up or otherwise archived. For one aspect of archive bit control, files that have the archive bit set are selected for certification processing. For another aspect of archive bit control, for files having an archive bit, the bit is cleared after the file is fingerprinted.

In response to the run schedule parameters in element 20, element 18 initiates the fingerprinting operations, further described below, in computer 12. For example, if an hourly run schedule is selected in element 20, element 18 initiates the fingerprinting operations each hour until a period ends. Element 18 searches or “crawls” the locations designated by the search parameters and identifies files meeting the file identifier parameters. If, within a run, no files are found meeting the identifier parameters, element 18 sends a corresponding signal to report generator 30. For each selected file, element 18 computes a digital fingerprint. This fingerprint (sometimes called a file signature or hash) is computationally unique to the contents of the file. This means that any modifications to the file, no matter how slight, results in a different fingerprint value. This fingerprint is a one-way value. This means the fingerprint is computed based on file contents but the file contents can in no way be determined given a fingerprint. The present invention utilizes industry standard algorithms, such as Message Digest 5 (MD5) or Secure Hash Algorithm 1 (SHA1) for computing fingerprint. Therefore, it should be understood that any suitable fingerprint algorithm known in the art can be used by the present invention.

As described below, a copy of the digital fingerprint for each file selected for certification in computer 12 is stored in fingerprint memory location 32. Although location 32 is shown in the same computer 12 as the processing element, it should be understood that location 32 can be in a different computer 12 (not shown), and that the disposition of location 32 in different computers is included in the spirit and scope of the claims. It is possible that a digital fingerprint for the selected file already exists in computer 12, for example, the selected file has been previously certified by apparatus 10. Therefore, to prevent unnecessary operations in apparatus 10 and to prevent archive 20 from being overburdened with duplicate files, element 18 determines if the selected file has already been certified. In some aspects, the foregoing determination regarding previous certification is optional. In these aspects, the file parameters noted above include a “fingerprint repeat” select to enable or disable the determination function. Since the digital fingerprint for each file certified by apparatus 10 is stored in element 32, in some aspects, element 18 includes a comparison element 33 that compares the digital fingerprint of the selected file to the fingerprints stored in element 32. If the print for the selected file matches a print in location 32, the selected file has been previously certified and does not require further processing. Then, operations on the selected file are suspended. If the print for the selected file does not match any print in location 32, the selected file, hereafter referred to as the subject file, has not yet been certified, and the subject file and subject file fingerprint are further operated upon by processing element 18.

The first time a file is identified for certification within a certification period, element 18 creates ticket storage element 34, also known as a Bulk Certification Record (BCR). The BCR is a ticket that identifies the aggregating point for digital fingerprints in a given certification period. The BCR includes a detailed record or text file. Alternately, the same information in the BCR can be populated into a database at the user's election. After creating the BCR, element 18 signals transceiver element 24, which relays the signal to base transceiver element 36 in packaging element 26. Base transceiver element 36 assigns a BCR identifier (BCRI) for ticket storage element 34 and transmits the BCRI to transceiver 24. Transceiver 24 transmits the BCRI to ticket storage element 34. In some aspects, this value consists of the text “IPBCR” followed by 9 digits. Once the BCR is in place, element 18 adds the fingerprint for the subject file to the BCR. In some aspects, the BCR stores, for each digital fingerprint in the BCR, the time and/or date the digital fingerprint was created, and/or the file name.

In some aspects, element 18 automatically stores a copy of the digital fingerprint for the subject file in archive 20. In some aspects, element 18 stores a copy of the digital fingerprint for the subject file in archive 20 in response to a selection made by a user of apparatus 10, as described above for file parameters. In some aspects, element 18 automatically converts the file in archive 20 to a read-only file. This option prevents a user from inadvertently modifying a file that has been certified and archived, since such modification invalidates the original certification of the file. That is, the contents of the modified file would no longer match the contents of the file at the time the file was originally fingerprinted and certified. In some aspects, element 18 converts the file in archive 20 to a read-only file in response to a selection made by a user of apparatus 10, as described above for file parameters.

Processing element 18 simplifies operation of apparatus 10 for the user by making it easy for the user to select files to certify, save copies of certified files, and identify files that have been certified. For example, the user does not need to execute any steps beyond those already required for the particular program, for example, a word processing program, being used to generate or modify the file, once apparatus 10 is configured. In some aspects, element 18 automatically renames the subject file copy in archive 20 according to the syntax selected in element 22. In some aspects, element 18 renames the subject file copy in archive 20 according to the syntax selected in element 22 in response to a selection made by a user of apparatus 10, as described above for file parameters. In some aspects, the rename includes the original name for the selected file, to facilitate later identification of the file copy, and appends an identifier related to the certification process. For example, a file entitled “test.doc” can be modified to “test<.doc, where <> is the identifier. In some aspects, the identifier is the date and/or time of day that the file was digitally fingerprinted.

Generator 30 can provide a report for each session completed. The reports can be sent to computer 12, for example, to user interface 28 or to a database in computer 12. In some aspects, the user can select the database location using interface 28. Also, reports can be sent using email element 38. Generator 30 can provide a report for a successful session or a report for an unsuccessful session.

At the end of each session, element 18 passes the digital fingerprints in the BCR and the BCRI to transceiver element 24, which transmits the contents to base transceiver element 36 in computer 14. Only the fingerprints of the files, not the files themselves, are transmitted. In some some aspects, the BCR passes the date and/or time a digital fingerprint in the BCR was created. In some aspects, a file name for a digital fingerprint in the BCR is passed to element 24. In some aspects, the BCRI is written to the application log file, and can be included in any “success” message. Thus, the BCRI provides a means of tracing the transmission of a specific fingerprint to computer 14. Typically, transceiver 24 communicates with transceiver 36 using a network connection. It should be understood that any type of network connection known in the art can be used by apparatus 10. Examples of possible network connections include the Internet, FTP, and VPN. The first step in the communication is to verify information in a user file, identifying computer 12, so that fingerprint information can be attributed to a session specific to an account associated with computer 12. Multiple user files can be supplied to a single site, and the selection of the appropriate file is specified in a file in computer 14.

During transmission, element 24 constructs a session digital fingerprint, also referred to as a composite digital fingerprint, which is based on the data fingerprints accumulated during a respective session and their sequence within the BCR. In some aspects, the composite digital fingerprint incorporates the date and/or time a digital fingerprint in the BCR was created. The session fingerprint validates the set of fingerprints included in the session, and their order in the session. After all individual fingerprints are transmitted; the session fingerprint is transmitted to transceiver 36 for validation by computer 14. Transceiver 36 constructs a second session fingerprint for the fingerprint data received at computer 14. If there is a mismatch between the session fingerprint sent from computer 12 and the value computed by transceiver 36, this indicates that an error has occurred during transmission, and transceiver 36 sends an error message to the transceiver 24. In turn, transceiver 24 notifies generator 30, which can provide a report regarding the error.

Computer 14 also includes compiling element 40, sequencing element 42, and publishing element 44. Typically, computer 14 is enabled to receive BCR information from multiple users (not shown). In some aspects, computer 14 also receives other unrelated files corresponding to other documentation processes. Compiling element 40 creates a periodic summary file, which summarizes the activities of computer 14 in the course of a certification period. In some aspects, this summary file is called a Daily Certification Record (DCR). Thus, the DCR lists the BCRs and unrelated files received during a certification period. Sequencing element 42 creates a digital fingerprint of the DCR and assigns a respective sequential number to the DCR and the digital fingerprint of the DCR. Publishing element 44 publishes the DCR, the DCR fingerprint, and the respective sequential numbers. In some aspects, element 44 publishes in an electronic registry available to the public (not shown). In some aspects, element 44 publishes in a print journal available to the public (not shown). In some aspects, the electronic registry and the print journal are published daily and monthly, respectively.

In some aspects (not shown), apparatus 10 does not copy a subject file and therefore, apparatus 10 does not include archive 20 or an alternate storage location. For these aspects, file parameters in element 22 include a read-only select, to convert a subject file to a read-only file, and a rename select, to rename a subject file. The read-only conversion and renaming operations are as described above for the copy of the subject file in archive 20. For the foregoing aspects, the remainder of the operations described above for apparatus 10 is applicable.

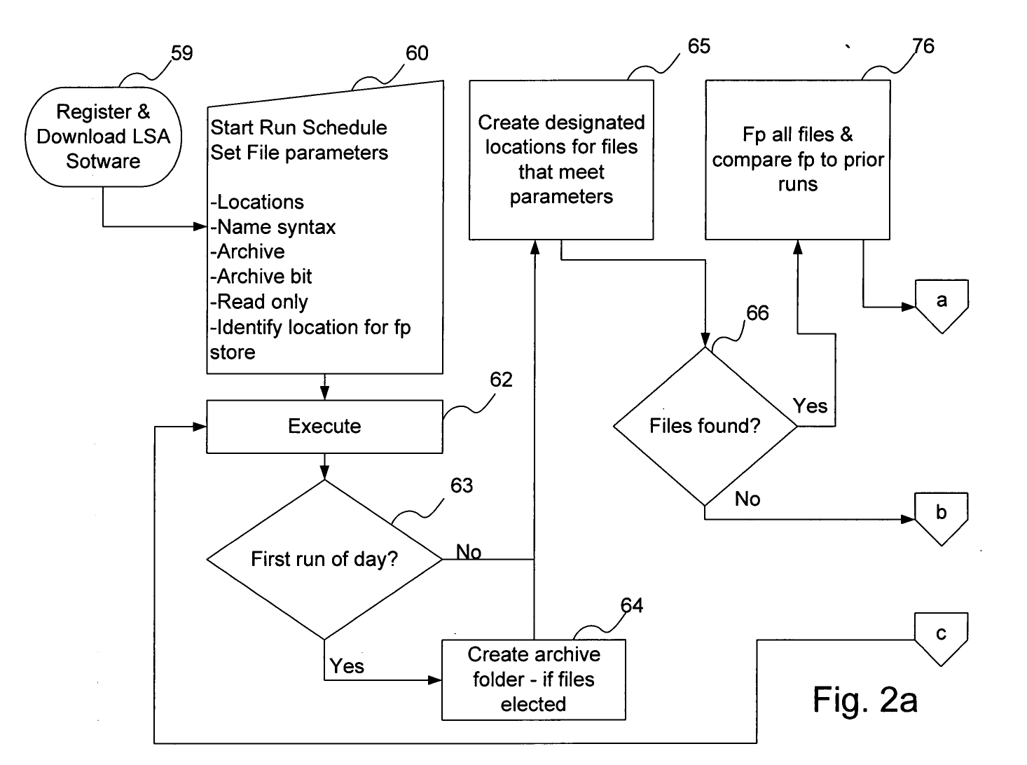

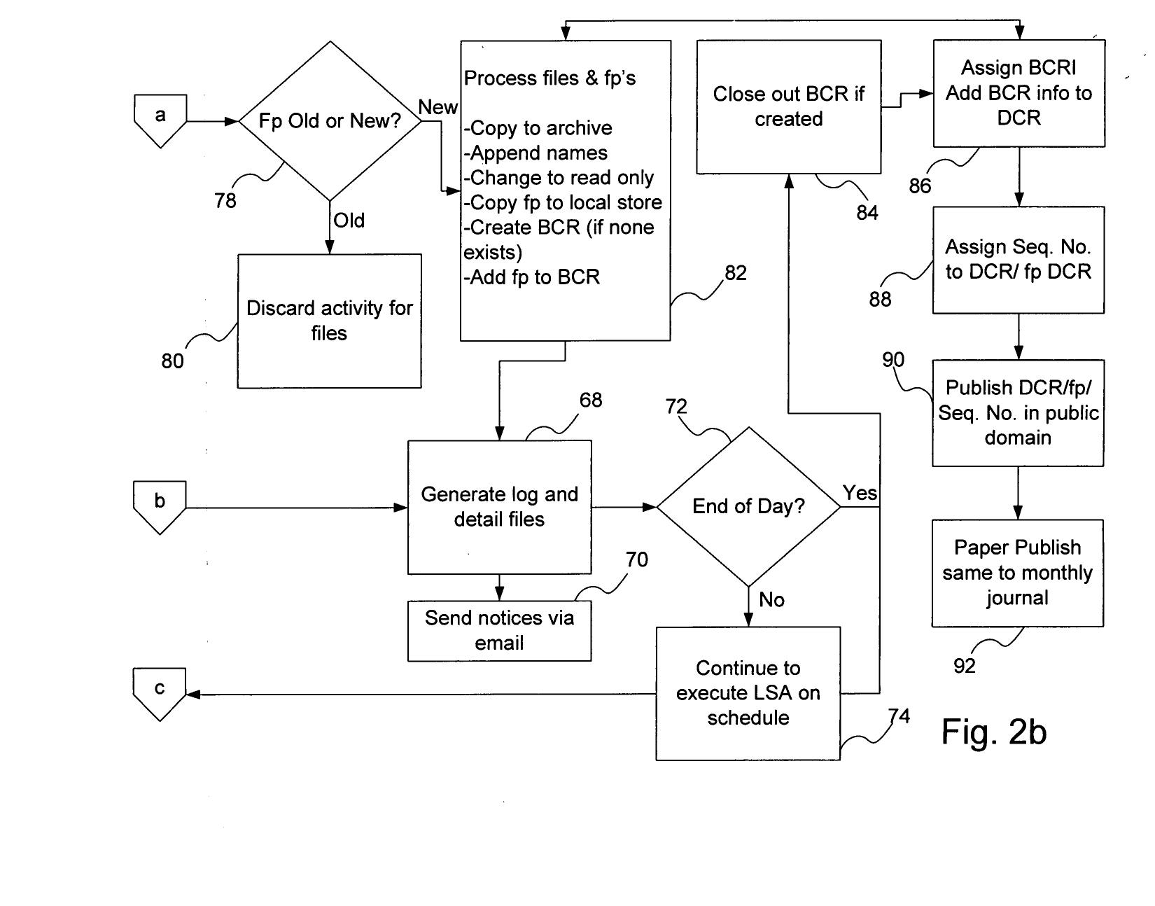

FIGS. 2a and 2b are a process flow chart illustrating a present invention computer-based method and apparatus for certifying a file. In FIGS. 2a and 2b, a certification period is shown as one day (24 hours). However, it should be understood that the certification period can of a different duration and that such durations are within the spirit and scope of the claims. Steps 59 through 84 take place within a specially programmed computer, hereafter referred to as the local computer. Steps 86-92 take place within a specially programmed base computer, typically remote from the local computer. Step 59 registers a user and downloads present invention software into the local computer. Session schedule and file parameters are set and selected in step 60. These parameters include file search parameters, file identification parameters, name syntax, archiving options, archive bit options, an option to convert a file to a read-only file, and an option to select a location for storing digital fingerprints generated by the present invention. Step 62 initiates the first session, or execution of the fingerprinting operations, shown from steps 63 to 84. Step 63 determines if the session is the first of the respective certification period. If yes, step 64 creates an archive file, if this option is selected in step 60, and the process moves to step 65. If no, the process moves to step 65, which searches or crawls the locations selected in step 60 to find suitable files according to the file identification parameters selected in step 60. Step 66 queries the status of the search. If no files are found, step 68 is notified and step 68 can send a status report. In some aspects, step 70 is used to send a report via email. Step 72 queries the status with respect to the certification period. If it is not the end of the period, step 74 instructs step 62 to continue operations. The case for the end of the period is discussed below.

If step 66 identifies files, step 76 digitally fingerprints the identified files and compares the fingerprints to fingerprints in a fingerprint storage location selected in step 60. This location holds fingerprints for files already processed. In some aspects, the location holds fingerprints only for files processed earlier in the certification period or session. Step 78 queries the fingerprint comparison. If fingerprints match, then the identified file has already been processed and step 80 discontinues operations on the file. If fingerprints do not match, the file has not yet been processed, and step 82 processes the identified file.

If the identified file is the first file processed in the subject certification period, step 82 creates a BCR. Then, step 82 communicates with the base computer and step 86 assigns a BCR identifier (BCRI) for the BCR and communicates the BCRI to the first computer. Then, step 82 adds the fingerprint for the identified file to the BCR. If these options are selected in step 60, step 82 copies the file to the archive, appends the name for the copy in the archive according to the parameters selected in step 60 and changes the file in the archive to a read-only file. Step 82 also copies the fingerprint for the identified file to the fingerprint storage location. At the end of each session, for each file added to the BCR in that session, at least a portion of the information in the BCR is transmitted to the base computer in step 82. Step 82 also creates a session fingerprint and transmits the session fingerprint to the base computer. Step 86, in turn, computes a second session fingerprint for the information actually received in the base computer and compares the first and second session fingerprints. If the fingerprints do not match, an error has occurred during transmission and step 86 notifies the local computer of the error. Step 68 generates a report regarding the success or failure of operations in step 82.

If step 74 signals the end of the certification period, step 84 closes out the BCR. Then, Step 86 creates a period summary file, in some aspects, called a Daily Certification Record (DCR), and adds the BCR to the DCR. Step 88 digitally fingerprints the DCR and assigns a respective sequential number to the DCR and the digital fingerprint for the DCR. Step 90 publishes the DCR, the DCR fingerprint, and respective sequential numbers for the DCR and the DCR fingerprint in an electronic registry in the public domain. Step 92 publishes the DCR, the DCR fingerprint, and the respective sequential numbers for the DCR and the DCR fingerprint in a paper journal.

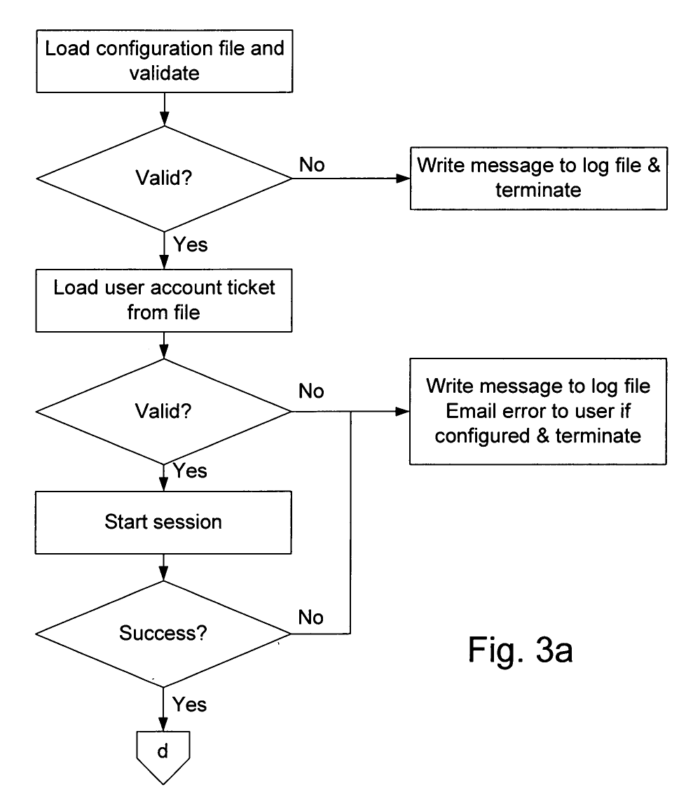

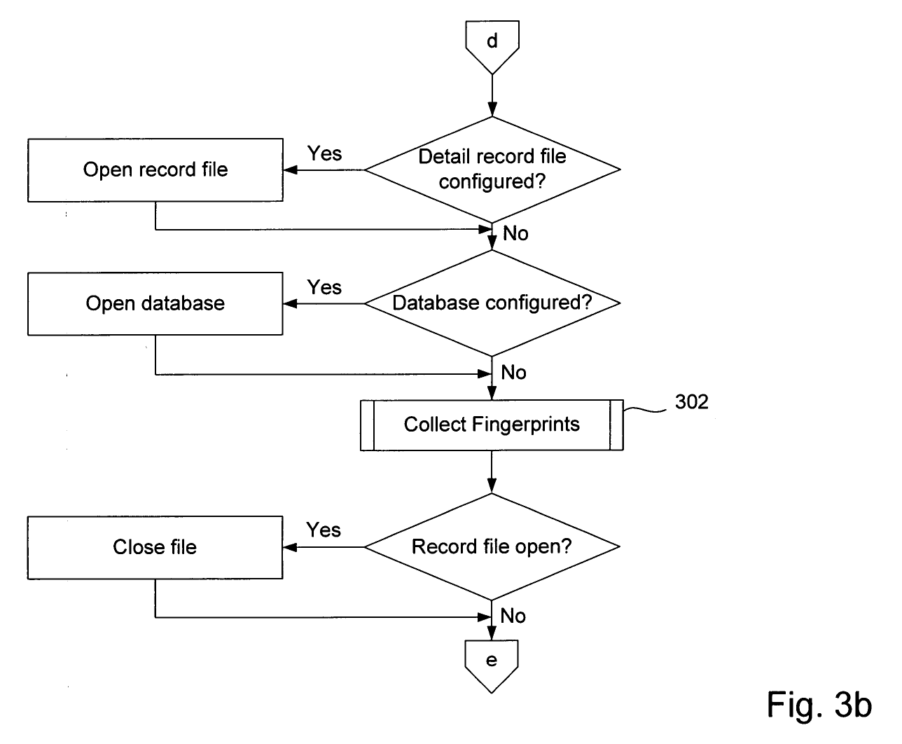

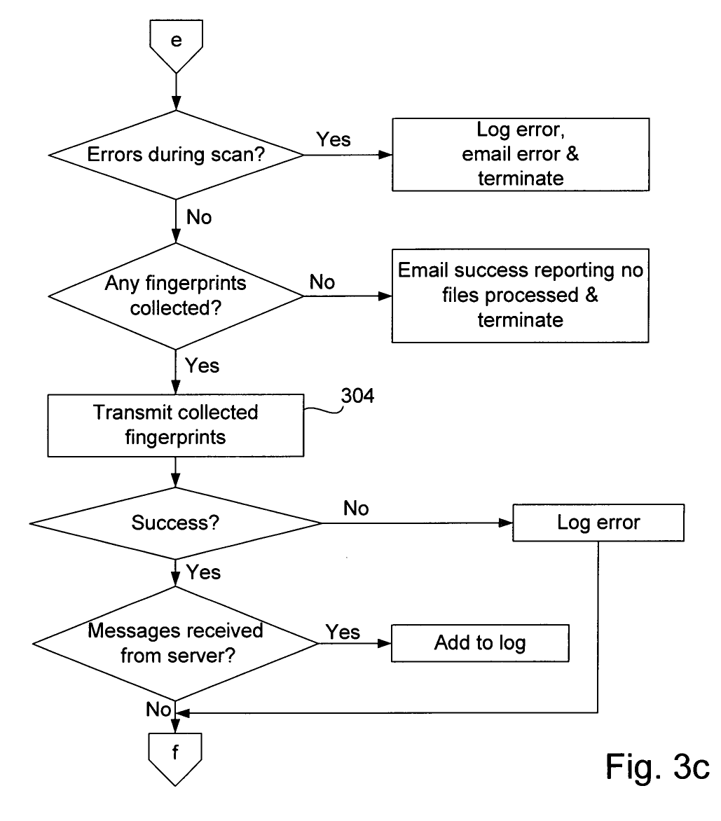

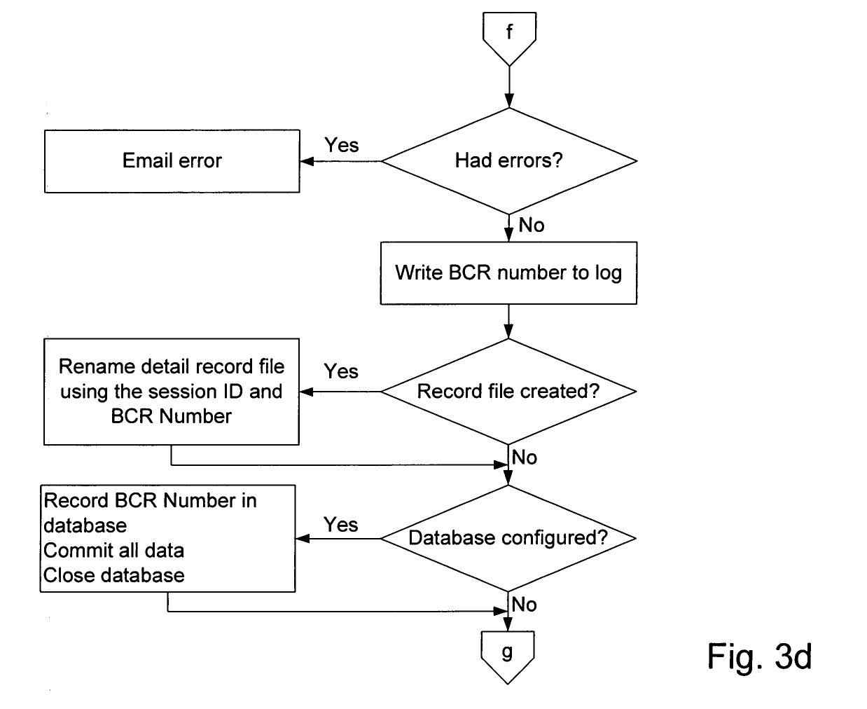

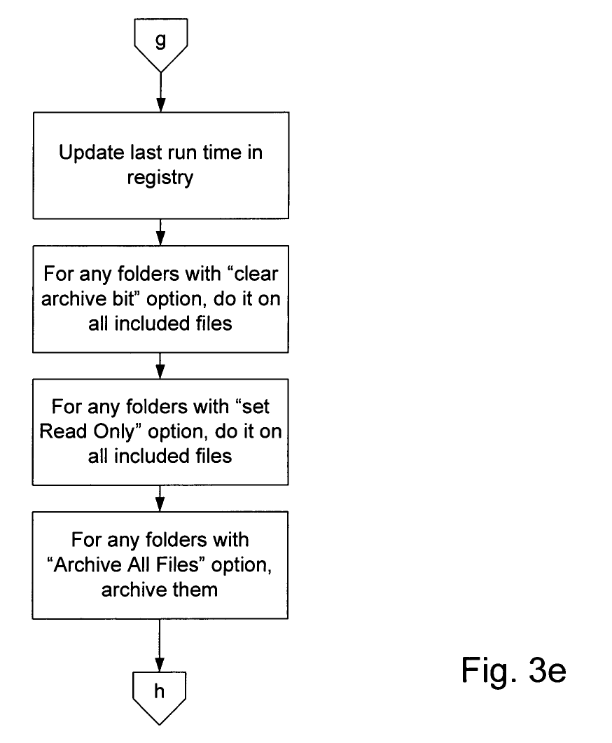

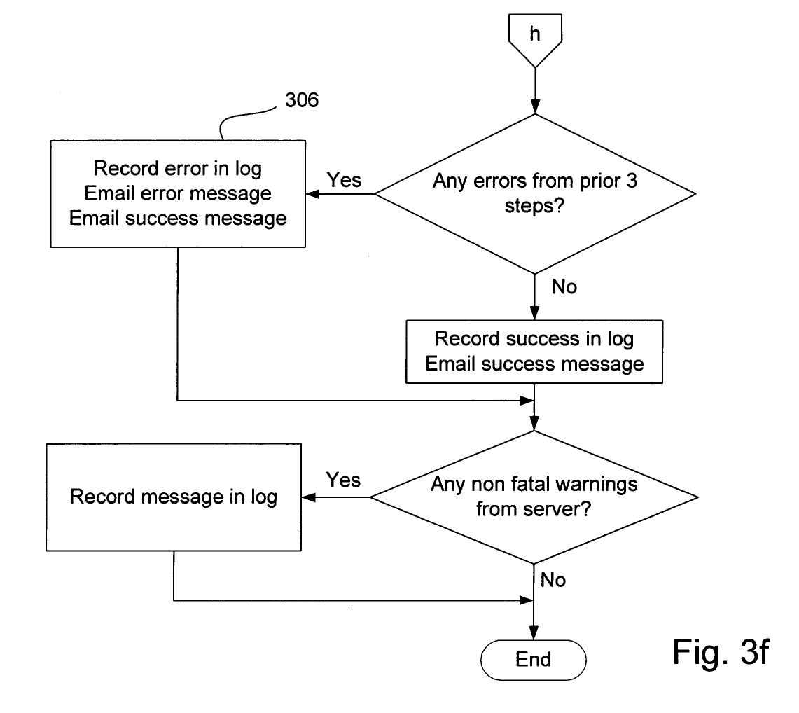

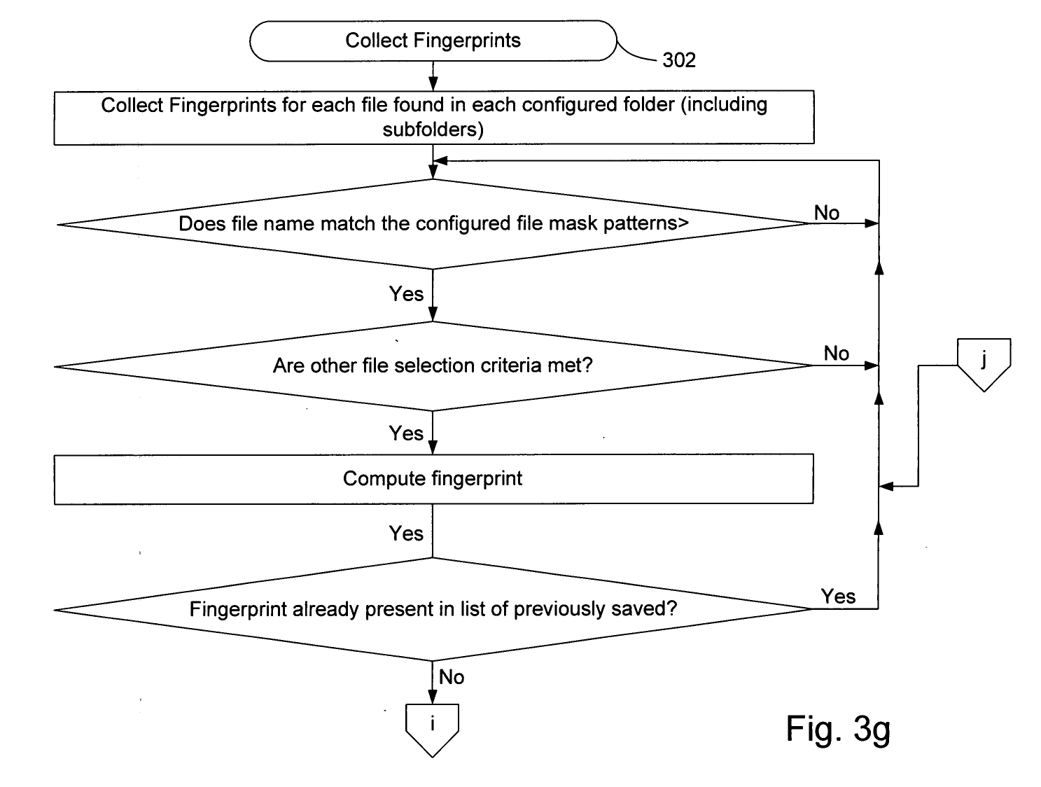

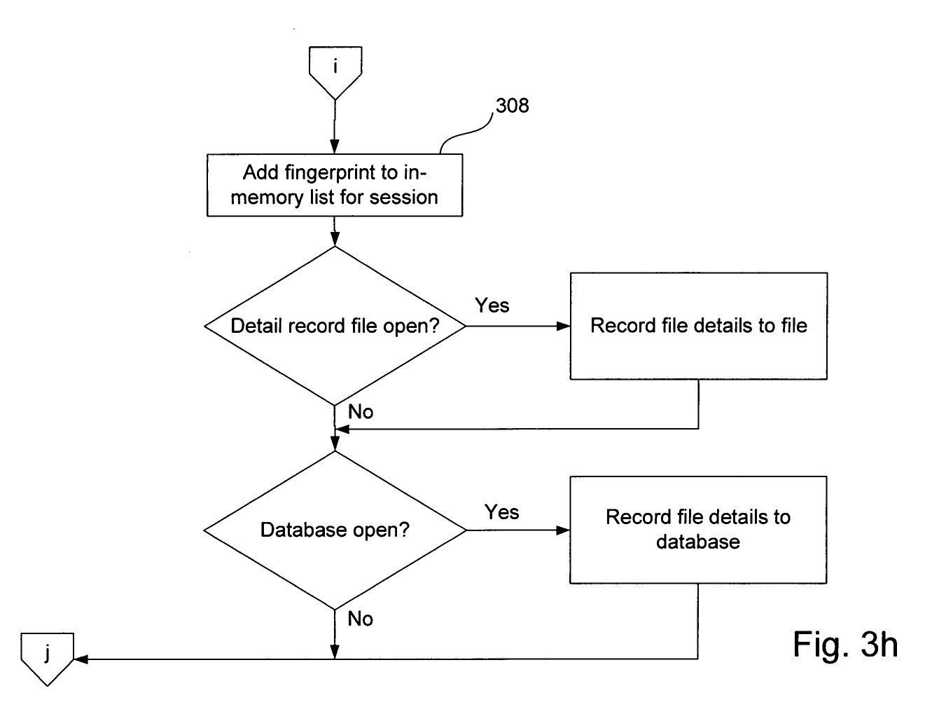

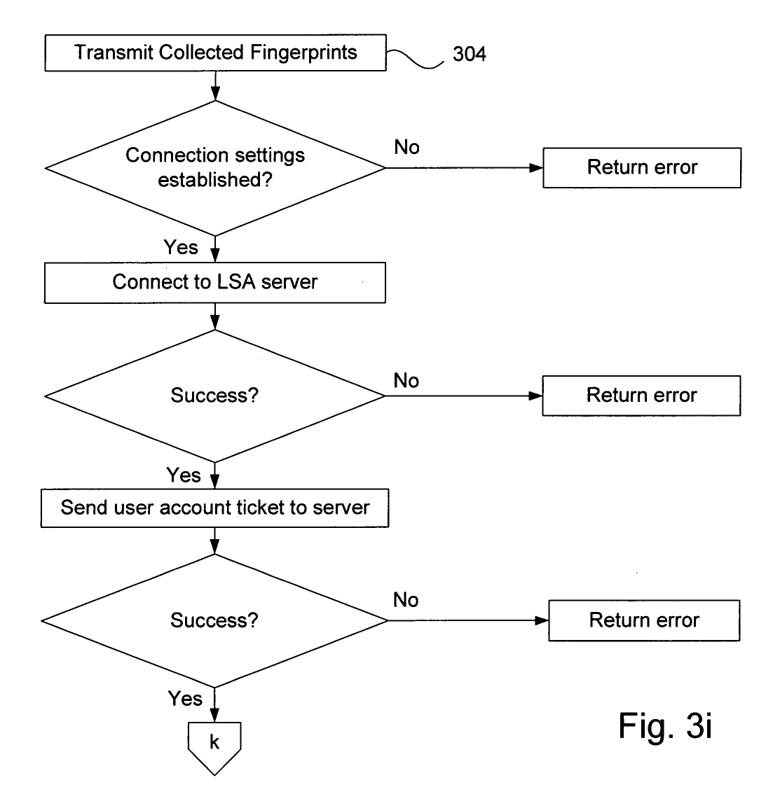

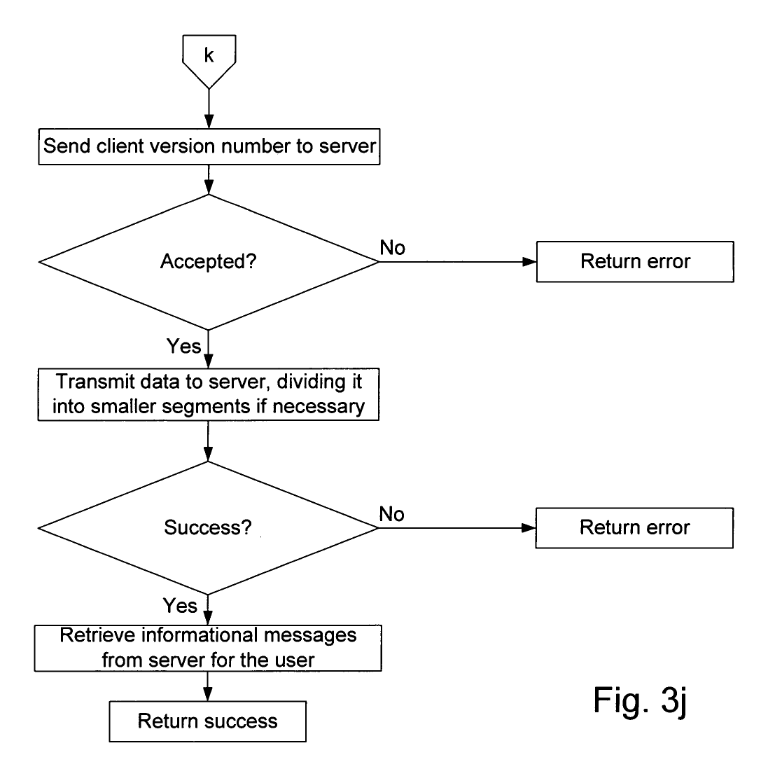

FIGS. 3a through 3f are a programming flow chart for a present invention method and apparatus.

FIGS. 3g and 3h are a programming flow chart further illustrating the collection of digital fingerprints shown in FIGS. 3a through 3f.

FIGS. 3i and 3j are a programming flow chart further illustrating the transmission of collected of digital fingerprints shown in FIGS. 3a through 3f. FIGS. 3a through 3f, FIGS. 3g and 3h, and FIGS. 3i and 3j illustrate the basic framework, flow, decision-making, and logic of the present invention software. Step 302 in FIG. 3b is the starting point for FIG. 3g. Step 304 in FIG. 3c is the starting point for FIG. 3i. Regarding Step 306 in FIG. 3f, since the errors cited in Step 306 occur after fingerprints are successfully sent to the server, both error and success messages are sent. Step 308 in FIG. 3h updates the session fingerprint. Details of the software can be found in the appended source code for the software.

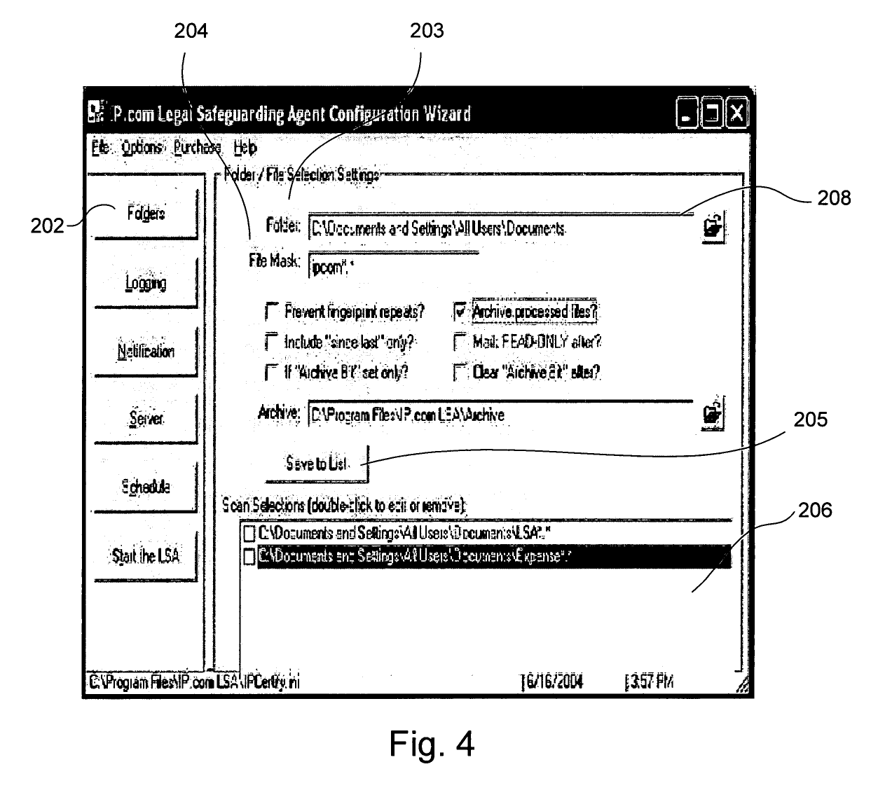

FIGS. 4 through 18 illustrate a best mode of the invention known to the inventors at the time of application for patent. Note that the present invention is referred to as the Legal Safeguarding Agent or the agent in the description of FIGS. 4 through 18. In FIGS. 4 through 18, a certification period is shown as one day (24 hours). However, it should be understood that the certification period can be of a different duration and that such durations are within the spirit and scope of the claims.

FIG. 4 is a screen capture illustrating the configuration tool of the agent. In this figure, the user is presented with the Legal Safeguarding Agent configuration tool. “Folders” 202 is selected, resulting in the screen shown. On this panel, the user can define the file locations and name characteristics of the files they wish to legally safeguard. “Folder” 203 represents where the agent looks for the specific files, while “File Mask” 204 represents the name characteristics that the agent uses to identify a file for certification. Once selections are made, the user selects “Save to List” 205 and the information will be added as a line item in the “Scan Selections” box 206. In this instance, the user has already directed the agent to look in the C:\Files and Settings\All Users\Files folder and look for any file that begins with the letters ‘LSA’ or ‘PJV’. The user is in the process of adding another selection in panel 208 for any files in this same location that begin with ‘ipcom.’

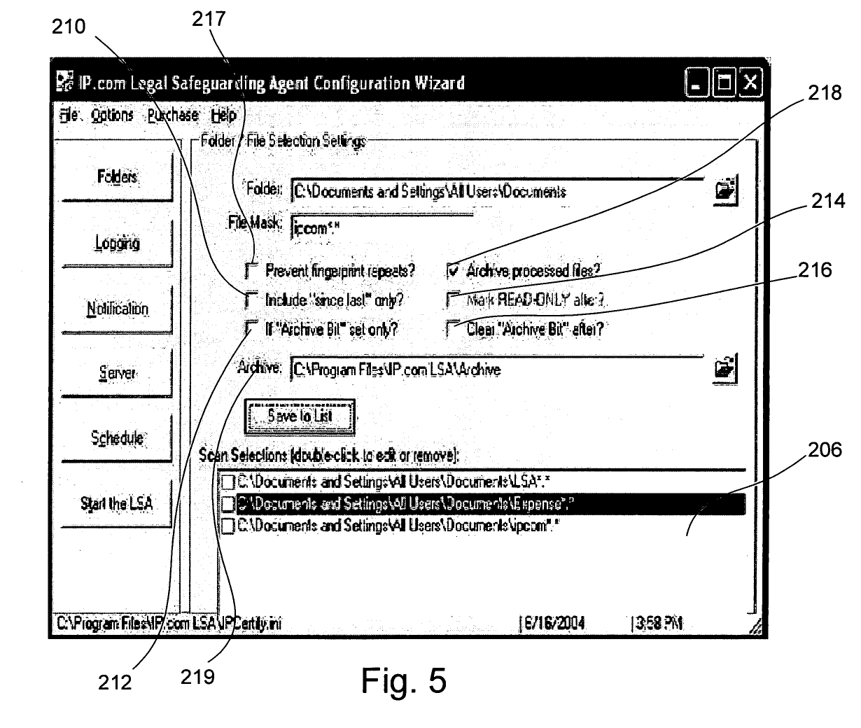

FIG. 5 is a screen capture further illustrating the configuration of the agent. After clicking “Save to List” 204, the control panel looks like FIG. 5. The following should be viewed in light of FIGS. 1 and 5. Note the three line items now included in the “Scan Selections” box 206. There are also five check boxes that the user can use to control the agent for any given line item of files. They are: ‘Include “since last” only?’ 210; ‘If “Archive Bit” set only?’ 212; ‘Mark “READ-ONLY” after?’ 214; and ‘Clear “Archive Bit” after?’ 216. When box 210 is checked, the agent is directed to only look for new files added to this location since the last time the agent was run. Some programs include an archive bit informing other programs that the file has been backed up or otherwise archived. When box 212 is checked, the agent is directed to process files that have the archive bit set. When box 214 is checked, the agent is directed to change the safeguarded files to a “read only” status to prevent inadvertent changes to the contents of the file. This helps to ensure that the file is available, in the original, unchanged condition, should the user need the file in the future. As noted above, some programs have an archive bit to inform other applications as to whether the file has been backed up or archived. If box 216 is checked, the agent is directed to clear the archive bit of a file after processing the file. “Prevent fingerprint repeats?” button 217 is used to select the functions described for elements 32 and 33 in FIG. 1, that is, preventing the processing of files that have previously been processed. “Archive processed files?” button 218 is used to select the functions described for elements 18 and 20 in FIG. 1, that is, archiving files after the files are processed by apparatus 10. “Archive” field 219 is used to select a location for the archive, which is element 20 in FIG. 1. Button 218 has been selected and a corresponding location for the archive has been entered in field 219.

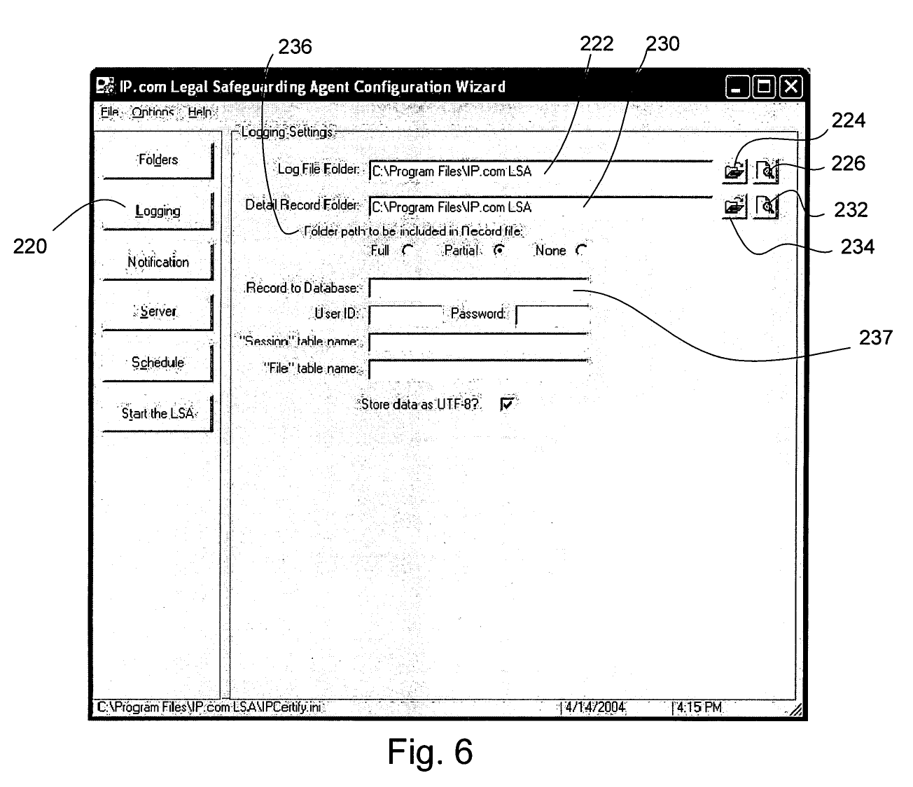

FIG. 6 is a screen capture further illustrating the configuration of the agent. “Logging” button 220 is selected and the window in FIG. 6 is presented. “Log File Folder” field 222 in this window indicates where the agent will save the Log File(s). The Log File is the file created to record operations of the agent. One Log File is created for each day (certification period), with all activity for that day being recorded in this single file. The Log File tracks when the agent ran, how many files were located, and the success or failure of the file processing. Clicking on the folder icon 224 next to field 222 allows the user to select folder locations for this file. Clicking on the paper icon 226 next to field 222 presents a list of the respective log files created each day that the agent has run, as shown in the next figure. “Detailed Record Folder” field 230 instructs the agent where to store the detailed records of the files fingerprinted by the agent. The Detailed Records include the date and time of the activity, the hash or fingerprint generated by each file, and the file name. Clicking on the folder icon 232 next to this field 230 enables the user to select the folder location for storing the Detailed Records. Clicking on the paper icon 234 next to field 230 presents the user with a list of Detailed Records that can be viewed for reference purposes. There is also an option 236 below field 230 to include the folder path in the Detailed Record file. The user also has the option of selecting a location in “Record to Database” field 237 for a database to store detailed record information.

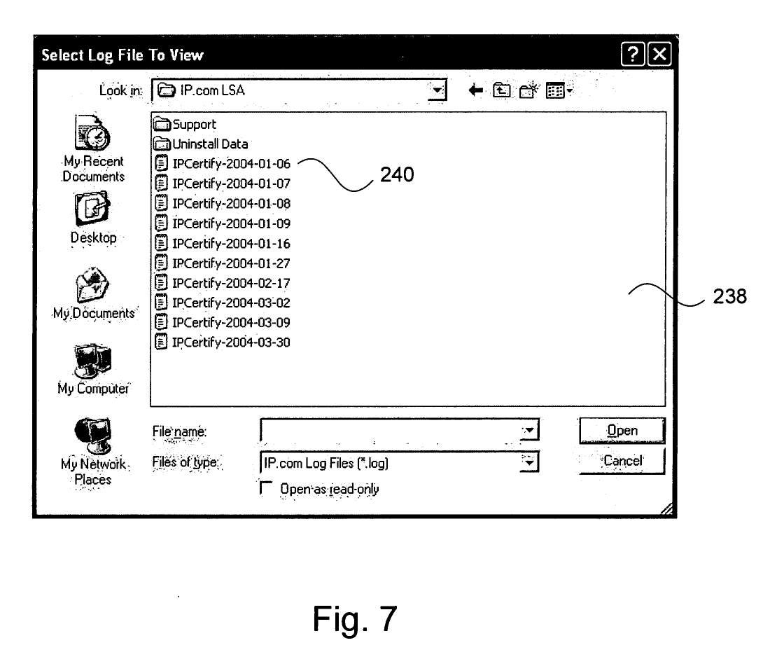

FIG. 7 is a screen capture illustrating a log file listing of the agent. A listing of the log files created each day that the agent has been run is shown in field 238. Selecting one of the logs, for example, log 240 shows a log of the activity for each session of the agent on that day such as, how many files were found, session numbers, and the BCR number.

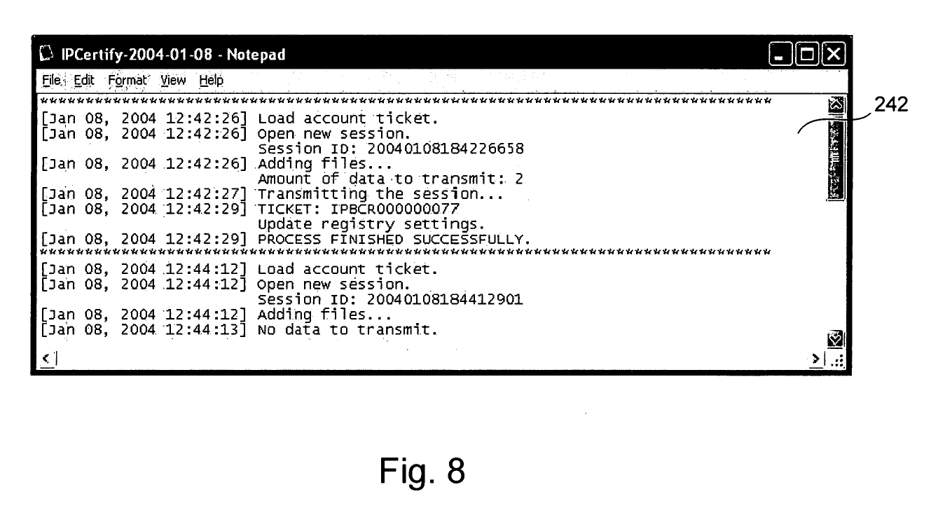

FIG. 8 is a screen capture illustrating a log file of the agent. The log file in FIG. 8 displays a message in window 242 that the agent ran successfully, that the agent located two files, and that the agent included the fingerprints of these two files in a Bulk Certification Record (BCR) number. Each BCR is published online and in the IP.com Journal on a monthly basis.

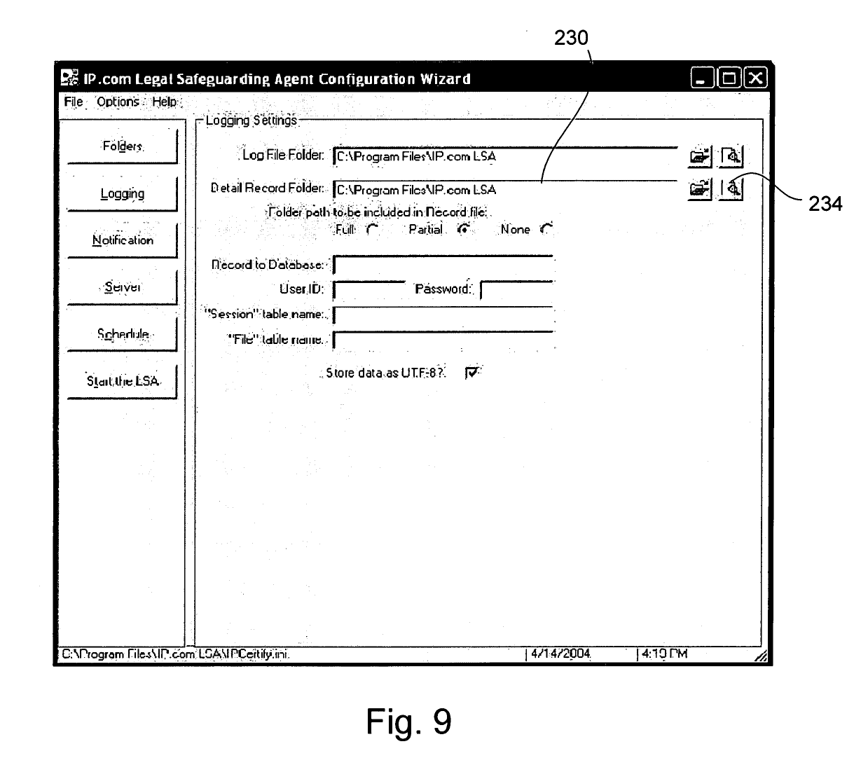

FIG. 9 is a screen capture illustrating the main folders page of the agent. FIG. 9 is a display of the main folders page for the agent. This page can be used to access a detailed record folder. The folder to access is shown in “Detailed Record Folder” 230 and the report is displayed, as shown in the next figure, by clicking on button 234.

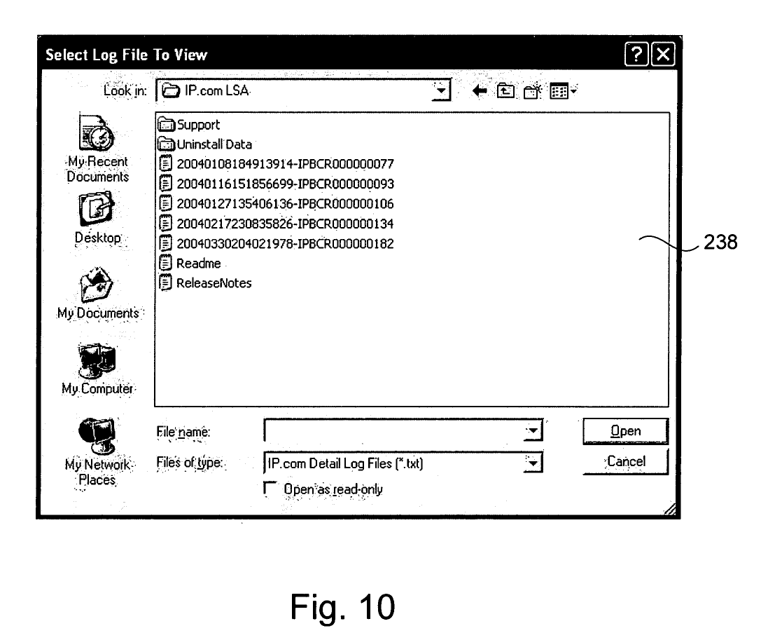

FIG. 10 is a screen capture illustrating a Detailed Record listing of the agent. As in FIG. 7, a listing of the log files created each day that the agent has been run is shown in field 238. The log files are displayed in response to clicking button 234 in FIG. 9.

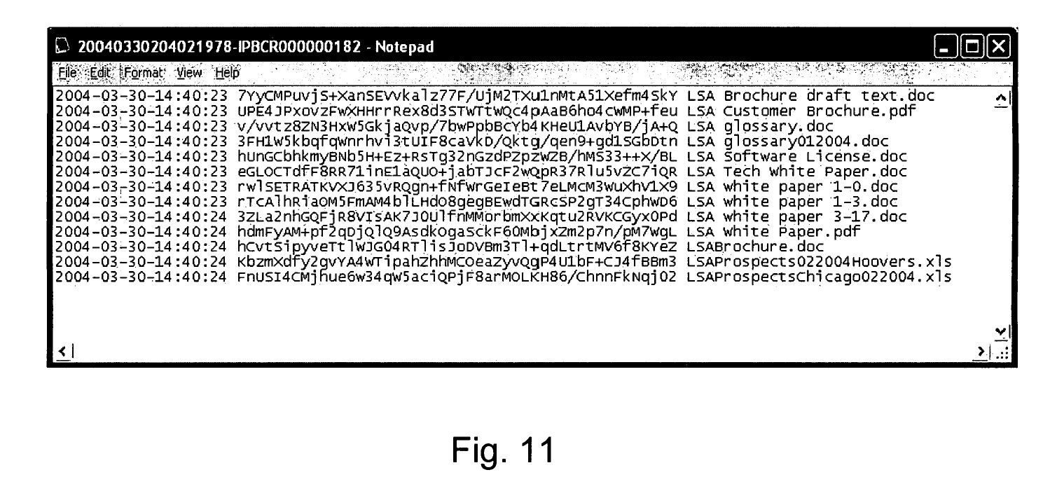

FIG. 11 is a screen capture illustrating a detailed record of the agent.

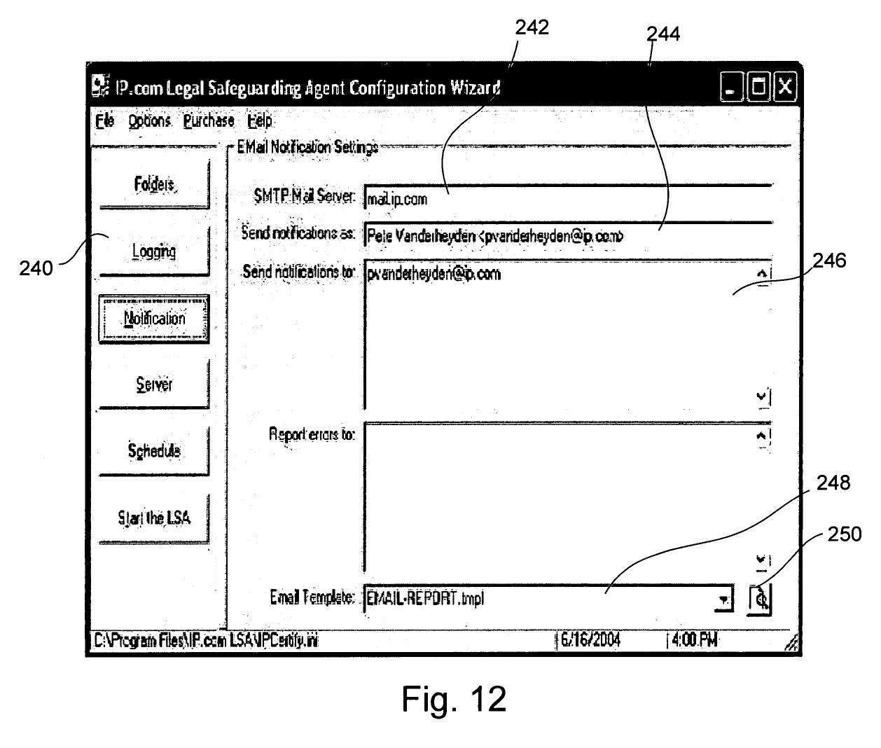

FIG. 12 is a screen capture illustrating the notification aspects of the agent. The user has clicked on “Notifications” button 240, resulting in the window shown in FIG. 12. The panel in FIG. 12 controls how notifications are sent, and to whom notifications are sent. The agent allows the user to automatically be notified (or to notify others) every time that the agent is executed. This function can be particularly useful when the agent is set to run at regular intervals and the user wishes to be apprised of the success of the runs or of any problems encountered during the runs. Field “SMTP Mail Server” 242 is not modified. In the aspect of the present invention shown, the server in field 242 is the server at the site of the base computer, which controls the outgoing mail. Field “Send notifications as” 244 selects the entity identified as the source of the email notification. Field “Send notifications to” 246 selects the recipients of the email notifications. Multiple recipients can be selected. Note that email notifications are sent automatically by the agent. Field “Success Template” 248 selects the email template used by the agent after a successful run. Clicking on the paper icon 250 next to field 248 enables the user to edit the template or select another template.

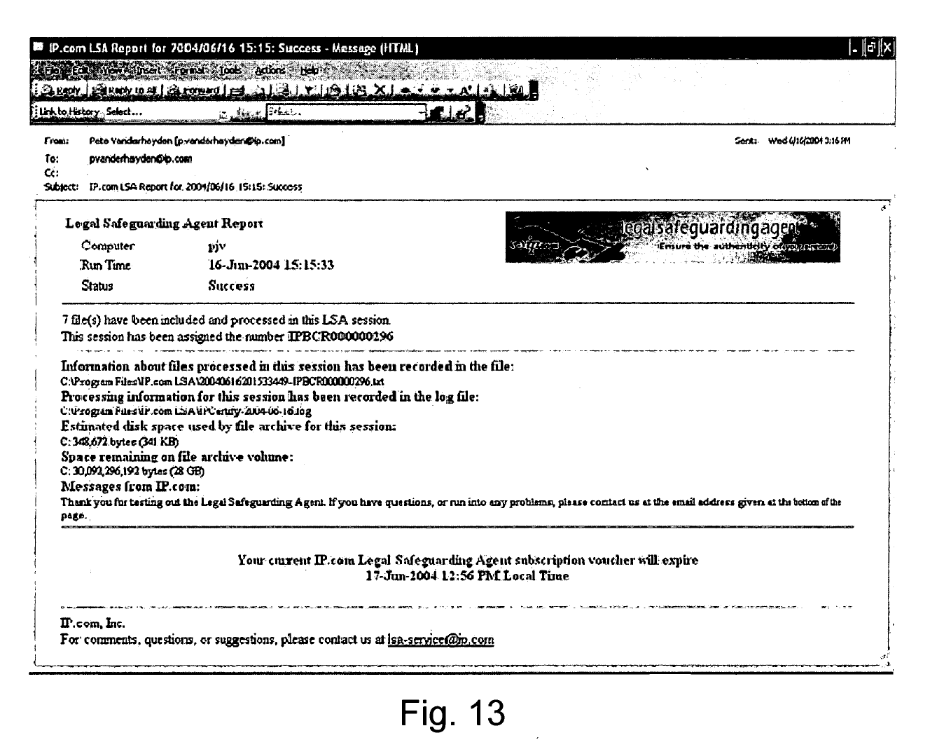

FIG. 13 is a screen capture illustrating an email notification of a successful session of the agent. For the case in which the user has elected to be notified, FIG. 13 is an example of a “Success Report.”

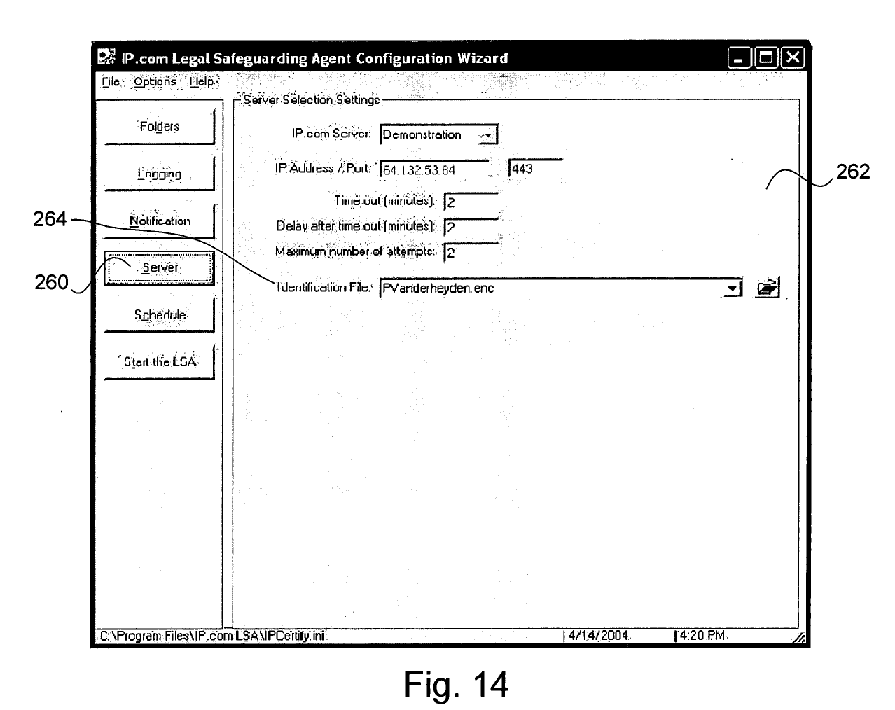

FIG. 14 is a screen capture illustrating server settings of the agent. Clicking on the “Server” button 260 results in the window shown in FIG. 14. Field “Server Settings” 262 displays information about the base computer server and ports used for communication with the agent. Typically, field 262 is a default setting and does not need modification. Field 262 also includes time-out information to control the behavior of the software in the event that a problem is encountered in the transmission process. Field “Identification File” 264 displays the Identification File for the registered user assigned to the agent software. This file is created by the base computer based on the information provided by the user at the time of registration. Typically, this file does not require changes.

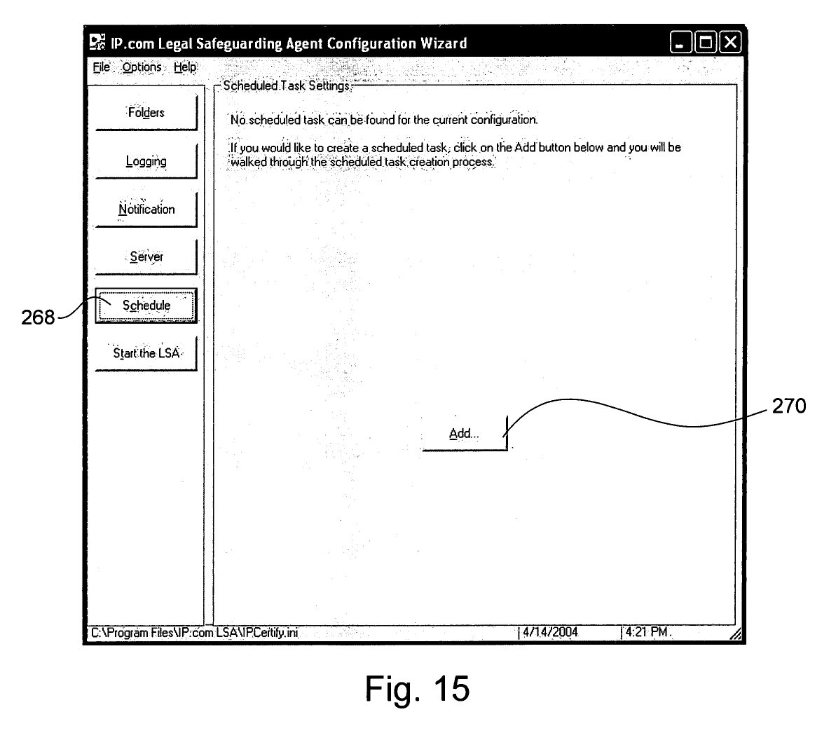

FIG. 15 is a screen capture illustrating scheduling of the agent. Clicking on the “Schedule” button 268 results in the window shown in FIG. 15. The window in FIG. 15 enables the user to set up a regular schedule for running the agent automatically. To set up a regular schedule, the user clicks on “Add” button 270.

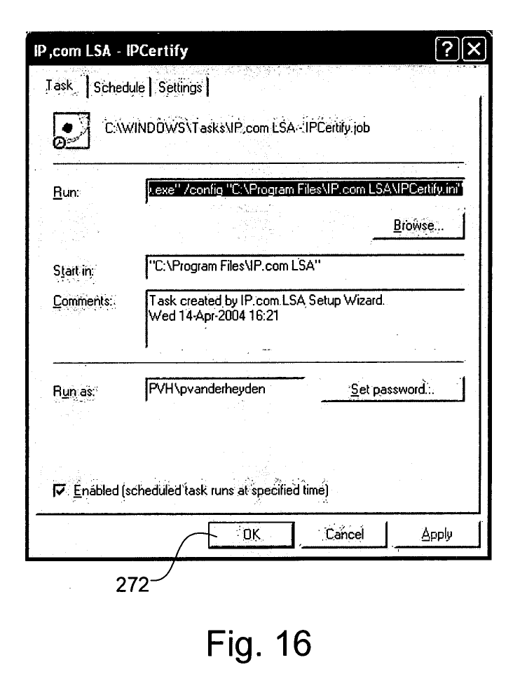

FIG. 16 is a screen capture further illustrating scheduling of the agent. The Task Scheduler, displayed in FIG. 16, is a Microsoft Windows® application. The Task Scheduler can be used to set the agent to run at various times and time intervals. Clicking “OK” button 272 after setting all necessary parameters enables the agent to run automatically as configured in FIG. 16.

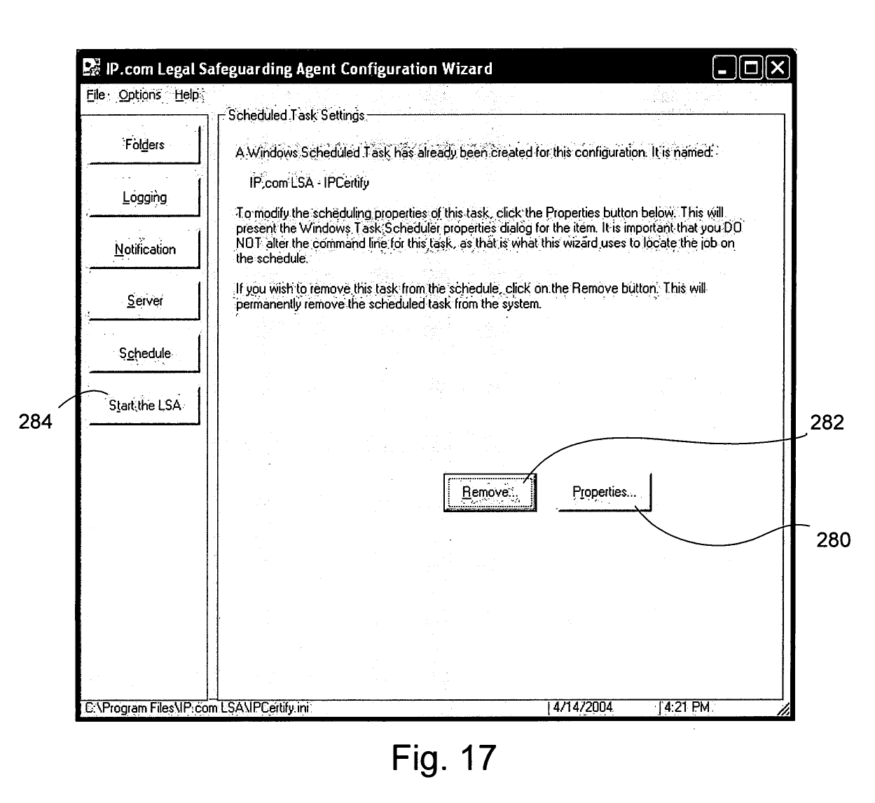

FIG. 17 is a screen capture further illustrating scheduling of the agent. After clicking button 272 in the FIG. 16, the window in FIG. 17 is displayed. The user can change properties of the scheduled task by clicking on “Properties” button 280 at the bottom of the window in FIG. 17. The schedule task can be removed or disabled by clicking on “Remove” button 282. The user can run the agent “manually” by simply clicking on “Start the LSA” button 284. The agent immediately begins to scan for files and collect fingerprints when button 284 is selected.

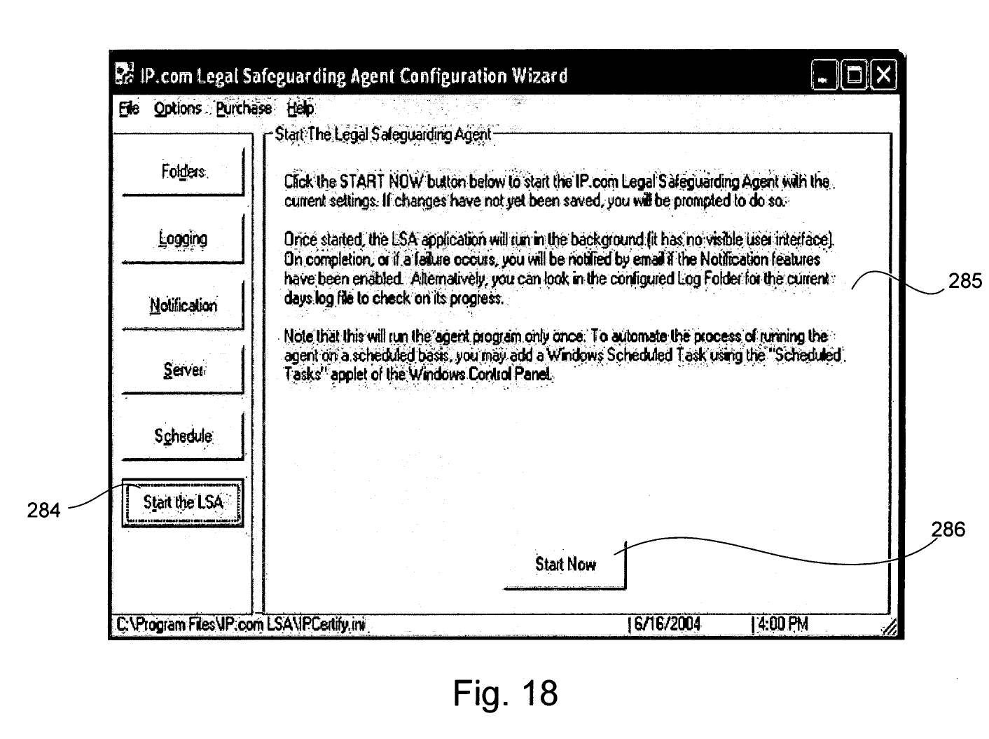

FIG. 18 is a screen capture illustrating start-up of the agent. The following should be viewed in light of FIGS. 1 through 18. In FIG. 18, button 284 has been clicked on. Field 285 contains various messages and instructions regarding the start-up and ongoing operation of the agent. The agent begins the actual operations described in FIGS. 1 through 18 when “Start Now” button 286 is clicked.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

1. A computer-based method for certifying a file, comprising the steps of:
creating a digital fingerprint for a first file;
generating a copy of said first file; and,
storing said copy of said first file in an archive, where said steps of creating, generating, and storing are performed by at least one general purpose computer specially programmed to perform said creating, generating, and storing.

2. The computer-based method for certifying a file as recited in claim 1 further comprising: specifying a time to generate said copy of said first file; and selecting a location for said archive, where said specifying and selecting are performed by said at least one specially programmed computer.

3. The computer-based method for certifying a file as recited in claim 1 further comprising:
accepting input from a user;
specifying a time to generate said copy of said first file responsive to said input; and,
selecting a location for said archive responsive to said input, where said accepting, specifying, and selecting are performed by said at least one specially programmed computer.

4. The computer-based method for certifying a file as recited in claim 1 further comprising: converting said copy of said first file to a read-only file, where said conversion is performed by said at least one specially programmed computer.

5. The computer-based method for certifying a file as recited in claim 4 wherein said conversion is performed after creating a digital fingerprint for said first file.

6. The computer-based method for certifying a file as recited in claim 4 wherein said conversion is performed after storing said copy of said first file in said archive.

7. The computer-based method for certifying a file as recited in claim 1 wherein said first file comprises a file name; and,
the method further comprising: renaming said copy of said first file, where said renaming uniquely identifies said copy of said first file and incorporates at least a portion of said file name and said renaming is performed by said at least one specially programmed computer.

8. The computer-based method for certifying a file as recited in claim 7 wherein said renaming further comprises incorporating a date of said creation of said digital fingerprint of said first file.

9. The computer-based method for certifying a file as recited in claim 7 wherein said renaming further comprises incorporating a time of said creation of said digital fingerprint of said first file.

10. The computer-based method for certifying a file as recited in claim 1 further comprising: determining whether a digital fingerprint of said first file has previously been created, where said determining is performed by said at least one specially programmed computer.

11. The computer-based method for certifying a file as recited in claim 10 wherein said at least one specially programmed computer further comprises a first digital fingerprint and said determination further comprises:
comparing said digital fingerprint for said first file to said first digital fingerprint; and,
responsive to said comparison, executing a next operational step regarding said first file.

12. The computer-based method for certifying a file as recited in claim 11 wherein
said comparison further comprises determining that said digital fingerprint for said first file differs from said first digital fingerprint; and,
wherein said execution further comprises said generating said copy of said first file and said storing said copy of said first file in said archive.

13. The computer-based method for certifying a file as recited in claim 11 wherein said comparison further comprises determining that said digital fingerprint for said first file is identical to said first digital fingerprint; and,
wherein said execution further comprises ceasing operations on said first file.

14. The computer-based method for certifying a file as recited in claim 1 further comprising:
configuring said at least one specially programmed computer;
processing said first file;
transmitting information regarding said processed first file to a base computer, where said configuring, processing, and transmitting are performed by said at least one specially programmed computer; and,
packaging said information, where said packaging is performed by said base computer.

15. The computer-based method for certifying a file as recited in claim 14 wherein said configuring further comprises: designating at least one file parameter and a schedule for searching for said first file.

16. The computer-based method for certifying a file as recited in claim 15 wherein said at least one specially programmed computer further comprises: at least one file location and at least one storage location; and,
wherein designating file parameters and a schedule further comprises designating:
a search location, from said at least one file location, in which to search for said first file;
a location, from said at least one storage location, for storing said digital fingerprint for said first file;
a characteristic for use in selecting said first file;
a command to select said first file when an archive bit in said first file is set;
a command to clear an archive bit in said first file after processing said first file;
a command to convert said copy of said first file to a read-only file;
syntax for renaming said copy of said first file;
a command to enable said archive; and,
a time to initiate searching for said first file.

17. The computer-based method for certifying a file as recited in claim 16 wherein said first file is located in said search location and said processing further comprises searching for said first file in said search location and selecting said first file in accordance with said characteristic.

18. The computer-based method for certifying a file as recited in claim 17 wherein said at least one specially programmed computer further comprises a first digital fingerprint; and, the method further comprising:
determining that said digital fingerprint for said first file differs from said first digital fingerprint; and,
in response to said determination, generating said copy of said first file and storing said copy of said first file in said archive.

19. The computer-based method for certifying a file as recited in claim 18 wherein said first file has a file name and said processing further comprises:
creating a ticket storage location;
adding said digital fingerprint for said first file to said ticket storage location;
creating an appended name for said copy of said first file, in accordance with said syntax, where said appended name uniquely identifies said copy of said first file and incorporates at least a portion of said file name;
generating a ticket identifier for said digital fingerprint for said first file;
converting said copy of said first file to a read-only file; and,
storing said digital fingerprint for said first file.

20. The computer-based method for certifying a file as recited in claim 19 wherein said ticket identifier further comprises a date when said digital fingerprint for said first file was created.

21. The computer-based method for certifying a file as recited in claim 19 wherein said ticket identifier further comprises a time when said digital fingerprint for said first file was created.

22. The computer-based method for certifying a file as recited in claim 19 wherein said ticket identifier further comprises said appended name.

23. The computer-based method for certifying a file as recited in claim 19 wherein transmitting information further comprises signaling said base computer when said ticket storage location has been created; and,
wherein said packaging further comprises assigning an identification number to said ticket storage location, responsive to said signaling; and, communicating said identification number to said at least one specially programmed computer.

24. The computer-based method for certifying a file as recited in claim 19 wherein transmitting information further comprises transmitting said digital fingerprint for said first file and said ticket identifier.

25. The computer-based method for certifying a file as recited in claim 24 wherein said packaging further comprises determining whether said digital fingerprint for said first file and said ticket identifier are received by said base computer free of error.

26. The computer-based method for certifying a file as recited in claim 25 wherein said processing further comprises creating a first composite digital fingerprint from said digital fingerprint for said first file and said ticket identifier;
wherein transmitting information further comprises transmitting said digital fingerprint for said first file, said ticket identifier, and said first composite digital fingerprint to said base computer; and,
wherein said packaging further comprises: receiving said digital fingerprint for said first file, said ticket identifier, and said first composite digital fingerprint; creating a second composite digital fingerprint from said digital fingerprint for said first file and said at least one ticket identifier as received at said base computer; and comparing said first and second composite digital fingerprints.

27. The computer-based method for certifying a file as recited in claim 26 wherein comparing said first and second composite digital fingerprints further comprises determining said first and second composite digital fingerprints differ and transmitting an error message to said at least one specially programmed computer.

28. The computer-based method for certifying a file as recited in claim 27 wherein said packaging further comprises publishing at least a portion of said information regarding said first file in a public domain.

29. The computer-based method for certifying a file as recited in claim 28 wherein said base computer further comprises a periodic summary file and said compiling further comprises:
adding said information regarding said digital fingerprint for said first file to said periodic summary file;
creating a digital fingerprint for said periodic summary file; and,
assigning a respective sequential number to said periodic summary file and said digital fingerprint for said periodic summary file.

30. The computer-based method for certifying a file as recited in claim 29 wherein said publishing further comprises electronically publishing said periodic summary file, said digital fingerprint for said periodic summary file, and said respective sequential numbers for said periodic summary file and said digital fingerprint for said periodic summary file.

31. The computer-based method for certifying a file as recited in claim 29 wherein said publishing further comprises publishing said periodic summary file, said digital fingerprint for said periodic summary file, and said respective sequential numbers for said periodic summary file and said digital fingerprint for said periodic summary file in a print media.

32. The computer-based method for certifying a file as recited in claim 29 wherein said processing further comprises generating a report regarding operation of said at least one specially programmed computer.

33. The computer-based method for certifying a file as recited in claim 29 wherein said processing further comprises generating a report regarding operation of said base computer.

34. The computer-based method for certifying a file as recited in claim 29 wherein said processing further comprises generating a report regarding operation of said at least one specially programmed computer and said base computer and transmitting said report via email.

35. The computer-based method for certifying a file as recited in claim 15 further comprising: accepting input from a user; and,
wherein said designation further comprises designating said at least one file parameter and said schedule for searching for said first file in response to said input, where said accepting is performed by said at least one specially programmed computer.

36. A computer-based method for certifying a file, comprising the steps of:
configuring at least one specially programmed computer;
processing a first file, where said processing comprises creating a digital fingerprint for said first file;
transmitting information regarding said first file to a base computer, where said configuring, processing, and transmitting are performed by said at least one specially programmed computer; and,
packaging said information, where said packaging is performed by said base computer.

37. The computer-based method for certifying a file as recited in claim 36 wherein said configuring further comprises designating at least one file parameter and a schedule for searching for said first file.

38. The computer-based method for certifying a file as recited in claim 36 wherein said at least one specially programmed computer further comprises: at least one file location and at least one storage location; and,
wherein designating file parameters and a schedule further comprises designating:
a search location, from said at least one file location, in which to search for said first file;
a location, from said at least one storage location, for storing said digital fingerprint for said first file;
a characteristic for use in selecting said first file;
a command to select said first file when an archive bit in said first file is set;
a command to clear an archive bit in said first file after processing said first file;
a command to convert said copy of said first file to a read-only file;
syntax for renaming said copy of said first file; and,
a time to initiate searching for said first file.

39. The computer-based method for certifying a file as recited in claim 38 wherein said at least one specially programmed computer further comprises a first digital fingerprint and wherein said first file has a file name; and,
the method further comprising:
determining that said digital fingerprint for said first file differs from said first digital fingerprint; and,
in response to said determination: creating a ticket storage location; adding said digital fingerprint for said first file to said ticket storage location; creating an appended name for said copy of said first file, in accordance with said syntax, where said appended name uniquely identifies said copy of said first file and incorporates at least a portion of said file name; generating a ticket identifier for said digital fingerprint for said first file; converting said copy of said first file to a read-only file; and storing said digital fingerprint for said first file.

40. The computer-based method for certifying a file as recited in claim 39 wherein transmitting information further comprises signaling said base computer when said ticket storage location has been created; and,
wherein said packaging further comprises assigning an identification number to said ticket storage location, responsive to said signaling; and, communicating said identification number to said at least one specially programmed computer.

41. The computer-based method for certifying a file as recited in claim 40 wherein transmitting information further comprises transmitting said digital fingerprint for said first file and said ticket identifier; and,
wherein said packaging further comprises determining whether said digital fingerprint for said first file and said ticket identifier are received by said base computer free of error.

42. The computer-based method for certifying a file as recited in claim 41 wherein said processing further comprises creating a first composite digital fingerprint from said digital fingerprint for said first file and said ticket identifier;
wherein transmitting information further comprises transmitting said digital fingerprint for said first file, said ticket identifier, and said first composite digital fingerprint to said base computer; and,
wherein said packaging further comprises: receiving said digital fingerprint for said first file, said ticket identifier, and said first composite digital fingerprint; creating a second composite digital fingerprint from said digital fingerprint for said first file and said at least one ticket identifier as received at said base computer; and comparing said first and second composite digital fingerprints.

43. The computer-based method for certifying a file as recited in claim 42 wherein comparing said first and second composite digital fingerprints further comprises determining said first and second composite digital fingerprints differ and transmitting an error message to said at least one specially programmed computer.

44. The computer-based method for certifying a file as recited in claim 43 wherein said publishing further comprises publishing at least portions of said information regarding said first file in a public domain.

45. The computer-based method for certifying a file as recited in claim 44 wherein said processing further comprises generating a report regarding operation of said at least one specially programmed computer and said base computer.

46. The computer-based method for certifying a file as recited in claim 45 wherein generating a report further comprises transmitting said report via email.

47. The computer-based method for certifying a file as recited in claim 37 further comprising: accepting input from a user; and,
wherein said designation further comprises designating said at least one file parameter and said schedule for searching for said first file in response to said input, where said accepting is performed by said at least one specially programmed computer.

48. A computer-based apparatus for certifying a file, comprising:
a processing element operatively arranged to create a digital fingerprint for a first file and to copy said first file; and,
an archive operatively arranged to store said copy of said first file, where said processing element and said archive are located in at least one computer.

49. The computer-based apparatus for certifying a file recited in claim 48 wherein said processor element is operatively arranged to generate information regarding said first file; and,
the apparatus further comprising:
a configuring element;
a transceiver element operatively arranged to transmit said information regarding said first file, where said configuring element and said transceiver element are located in said at least one computer; and,
a packaging element, in a base computer, operatively arranged to receive said information regarding said processed first file.

50. The computer-based apparatus for certifying a file recited in claim 49 wherein said configuring element is operatively arranged to designate at least one file parameter and a schedule for searching for said first file.

51. The computer-based apparatus for certifying a file recited in claim 50 wherein said at least one computer further comprises: at least one file location and at least one storage location; and,
wherein said configuring element is operatively arranged to designate:
a search location, from said at least one file location, in which to search for said first file;
a location, from said at least one storage location, for storing said digital fingerprint for said first file;
a characteristic for use in selecting said first file;
a command to select said first file when an archive bit for said first file is set;
a command to clear an archive bit for said first file after processing said first file;
a command to convert said copy of said first file to a read-only file;
syntax for renaming said copy of said first file;
a command to enable said archive; and,
a time to initiate searching for said first file.

52. The computer-based apparatus for certifying a file recited in claim 51 wherein said first file is located in said search location and said processing element is operatively arranged to:
locate said search location; and,
select said first file in accordance with said characteristic.

53. The computer-based apparatus for certifying a file recited in claim 52 wherein said processing element is operatively arranged to determine whether said fingerprint for said first file already exists in said at least one computer.

54. The computer-based apparatus for certifying a file recited in claim 53 wherein said at least one computer further comprises a first digital fingerprint; and,
wherein said comparison element is operatively arranged to copy said first file to said archive and to store said digital fingerprint for said first file when said digital fingerprint for said first file differs from said first digital fingerprint.

55. The computer-based apparatus for certifying a file recited in claim 53 wherein said at least one computer further comprises a second digital fingerprint; and,
wherein said comparison element is operatively arranged to cease operations on said first file when said digital fingerprint for said first file is identical to said second digital fingerprint.

56. The computer-based apparatus for certifying a file recited in claim 54 wherein said first file has a file name and said processing element is operatively arranged to:
create a ticket storage location;
add said digital fingerprint for said first file to said ticket storage location;
create an appended file name for said copy of said first file, in accordance with said syntax, where said appended name uniquely identifies said copy of said first file and incorporates at least a portion of said file name;
generate a ticket identifier for said digital fingerprint for said first file in said ticket storage location;
convert said copy of said first file to a read-only file; and,
store said digital fingerprint for said first file.

57. The computer-based apparatus for certifying a file recited in claim 56 wherein said ticket identifier further comprises a date when said digital fingerprint for said first file was created.

58. The computer-based apparatus for certifying a file recited in claim 56 wherein said ticket identifier further comprises a time when said digital fingerprint for said first file was created.

59. The computer-based apparatus for certifying a file recited in claim 56 wherein said ticket identifier further comprises said appended name.

60. The computer-based apparatus for certifying a file recited in claim 56 wherein said transceiver element is operatively arranged to signal said base computer when said ticket storage location is created; and,
wherein said packaging element further comprises a base transceiver element operatively arranged to assign an identification number to said ticket storage location, responsive to said signaling, and communicate said identification number to said at least one computer.

61. The computer-based apparatus for certifying a file recited in claim 60 wherein said transceiver element is operatively arranged to transmit said digital fingerprint for said first file and said ticket identifier.

62. The computer-based apparatus for certifying a file recited in claim 61 wherein said base transceiver element is operatively arranged to determine whether said digital fingerprint for said first file and said ticket identifier are received by said base computer free of error.

63. The computer-based apparatus for certifying a file recited in claim 62 wherein said processing element is operatively arranged to create a first composite digital fingerprint from said digital fingerprint for said first file and said ticket identifier;
wherein said transceiver element is operatively arranged to transmit said digital fingerprint for said first file, said ticket identifier, and said first composite digital fingerprint to said base computer; and,
wherein said base transceiver element is operatively arranged to receive said digital fingerprint for said first file, said ticket identifier, and said first composite digital fingerprint; create a second composite digital fingerprint from said digital fingerprint for said first file and said ticket identifier as received at said base computer; and compare said first and second composite digital fingerprints.

64. The computer-based apparatus for certifying a file recited in claim 63 wherein said base transceiver element is operatively arranged to transmit an error message to said at least one computer when said first and second composite digital fingerprints differ.

65. The computer-based apparatus for certifying a file recited in claim 64 wherein said packaging element further comprises: a compiling element operatively arranged to accept said information regarding said first file; and, a publishing element operatively arranged to publish said information regarding said first file in a public domain.

66. The computer-based apparatus for certifying a file recited in claim 65 wherein said packaging element is operatively arranged to generate a periodic summary file and said compiling element is operatively arranged to:
add said information regarding said digital fingerprint for said first file to said periodic summary file;
create a digital fingerprint for said periodic summary file; and,
assign a respective sequential number to said periodic summary file and said digital fingerprint for said periodic summary file.

67. The computer-based apparatus for certifying a file recited in claim 66 wherein said publishing element is operatively arranged to publish said periodic summary file, said digital fingerprint for said periodic summary file, and said respective sequential numbers for said periodic summary file and said digital fingerprint for said periodic summary file in a public domain.

68. The computer-based apparatus for certifying a file recited in claim 67 wherein said publishing element is operatively arranged to electronically publish said periodic summary file, said digital fingerprint for said periodic summary file, and said respective sequential numbers for said periodic summary file and said digital fingerprint for said periodic summary file.

69. The computer-based apparatus for certifying a file recited in claim 67 wherein said publishing element is operatively arranged to publish said periodic summary file, said digital fingerprint for said periodic summary file, and said respective sequential numbers for said periodic summary file and said digital fingerprint for said periodic summary file in a print media.

70. The computer-based apparatus for certifying a file recited in claim 64 wherein said processing element further comprises a report generator operatively arrange to generate a report regarding operation of said at least one computer and said base computer.

71. The computer-based apparatus for certifying a file recited in claim 70 wherein said report generator is operatively arrange to transmit said report via email.

72. The computer-based apparatus for certifying a file recited in claim 50 further comprising a user interface operatively arranged to accept input from a user; and,
wherein said configuring element is operatively arranged to designate said at least one file parameter and said schedule for searching for said first file responsive to said input.

73. A computer-based apparatus for certifying a file, comprising:
a processing element operatively arranged to generate information regarding said first file and create a digital fingerprint for said first file;
a configuring element operatively arranged to select at least one file parameter and a schedule for searching for said first file;
a transceiver element operatively arranged to transmit said information regarding said first file, where said configuring element and said transceiver element are located in said at least one computer; and,
a packaging element, in a base computer, operatively arranged to receive said information regarding said first file.

74. The computer-based apparatus for certifying a file recited in claim 73 wherein said at least one computer further comprises: at least one file location and at least one storage location; and,
wherein said configuring element is operatively arranged to select:
a search location, from said at least one file location, in which to search for said first file;
a location, from said at least one storage location, for storing said digital fingerprint for said first file;
a characteristic for use in selecting said first file;
a command to select said first file when an archive bit for said first file is set;
a command to clear an archive bit for said first file after processing said first file;
syntax for renaming said first file;
a command to convert said first file to a read-only file; and,
a time to initiate searching for said first file.

75. The computer-based apparatus for certifying a file recited in claim 74 wherein said first file is located in said search location and said processing element is operatively arranged to:
locate said search location; and,
select said first file in accordance with said characteristic.

76. The computer-based apparatus for certifying a file recited in claim 75 wherein said processing element is operatively arranged to determine whether said fingerprint for said first file already exists in said at least one computer.

77. The computer-based apparatus for certifying a file recited in claim 76 wherein said at least one computer further comprises a first digital fingerprint; and,
wherein said comparison element is operatively arranged to store said digital fingerprint for said first file when said digital fingerprint for said first file differs from said first digital fingerprint.

78. The computer-based apparatus for certifying a file recited in claim 76 wherein said at least one computer further comprises a second digital fingerprint; and,
wherein said comparison element is operatively arranged to cease operations on said first file when said digital fingerprint for said first file is identical to said second digital fingerprint.

79. The computer-based apparatus for certifying a file recited in claim 77 wherein said first file has a file name and said processing element is operatively arranged to:
create a ticket storage location;
add said digital fingerprint for said first file to said ticket storage location;
create an appended file name for said first file, in accordance with said syntax, where said appended name uniquely identifies said first file and incorporates at least a portion of said file name;
convert first file to a read-only file; and,
store said digital fingerprint for said first file.

80. The computer-based apparatus for certifying a file recited in claim 79 wherein said transceiver element is operatively arranged to signal said base computer when said ticket storage location is created; and,
wherein said packaging element further comprises a base transceiver element operatively arranged to assign an identification number to said ticket storage location, responsive to said signaling, and communicate said identification number to said at least one computer.

81. The computer-based apparatus for certifying a file recited in claim 80 wherein said transceiver element is operatively arranged to transmit said digital fingerprint for said first file and said ticket identifier.

82. The computer-based apparatus for certifying a file recited in claim 81 wherein said base transceiver element is operatively arranged to determine whether said digital fingerprint for said first file and said ticket identifier are received by said base computer free of error.

83. The computer-based apparatus for certifying a file recited in claim 82 wherein said packaging element further comprises a publishing element operatively arranged to publish said information regarding said first file in a public domain.

84. The computer-based apparatus for certifying a file recited in claim 83 wherein said processing element further comprises a report generator operatively arrange to generate a report regarding operation of said at least one computer and said base computer.

85. The computer-based apparatus for certifying a file recited in claim 84 wherein said report generator is operatively arrange to transmit said report via email.

86. The computer-based apparatus for certifying a file recited in claim 74 wherein said at least one computer further comprises: a user interface operatively arranged to accept input from a user; and,
wherein said configuring element is operatively arranged to select in response to said input.
